(19) United States
(12) Patent Application Publication
(10) Pub. No.: US 2010/0278550 A1
(43) Pub. Date: Nov. 4, 2010

(54) IMAGE FORMING APPARATUS AND IMAGE FORMING METHOD

(75) Inventors: Satoshi CHIBA, Suwa-shi (JP); Ken IKUMA, Suwa-shi (JP)

Correspondence Address: WORKMAN NYDEGGER;1000 Eagle Gate Tower, 60 East South Temple, Salt Lake City, UT, 84111, US

(73) Assignee: SEIKO EPSON CORPORATION, Tokyo (JP)

(21) Appl. No.: 12/769,078

(22) Filed: Apr. 28, 2010

(30) Foreign Application Priority Data
Apr. 30, 2009 (JP) 2009-110984

(51) Int. Cl. G03G 15/14

(52) U.S. Cl. 399/66; 399/313

(57) ABSTRACT

An image forming apparatus including a latent image bearing drum on which a latent image is formed, an exposure unit that exposes the latent image bearing drum, a developer unit that develops the latent image formed on the latent image bearing drum, a transfer medium onto which the image developed by the developer unit is transferred, and a transfer roller that transfers the image from the transfer medium to the transfer material, the transfer roller having a concaved portion extending in the axial direction and a support portion disposed on the outer circumference of the roller that supports the transfer material, where the outer circumference of the transfer roller being an integral multiple or an approximate integral multiple of the circumference of the latent image bearing drum.

### BACKGROUND OF THE INVENTION

The entire disclosures of Japanese Patent Application No. 2009-110984, filed Apr. 30, 2009 is expressly incorporated herein by reference.

1. Technical Field

The present invention relates to an image forming apparatus and image forming method. More specifically, the present invention relates to an apparatus and method that form an image by developing a latent image formed upon a photosensitive member using a liquid developer including of toner and a liquid carrier, transferring the resulting developer onto a medium such as recording paper, and fusing and fixing the toner image that has been transferred onto the medium.

2. Related Art

Various wet-type image forming apparatuses are known in the art that develop latent images using a high-viscosity liquid developer in which is dispersed toner including of solid components within a liquid carrier, thereby visualizing electrostatic latent images. The developer used in these wet-type image forming apparatuses has solid content or toner particles which are suspended within an electrically-insulative, high-viscosity organic carrier (carrier liquid) including of silicon oil, mineral oil, cooking oil, or the like. Typically, the toner particles are extremely small, with a particle diameter in the vicinity of 1 μm. Because the toner particles are so small, the wet-type image forming apparatuses are capable of realizing higher image qualities than dry-type image forming apparatuses, which use powder toner particles having a particle diameter of approximately 7 μm.

As an example of an image forming apparatus that uses such a liquid developer is found in Japanese Patent Doc. JP-A-2002-156839, which discloses an image forming apparatus that includes an image forming unit that forms an electrostatic latent image upon an image bearing member (photosensitive member), a developer unit that develops the electrostatic latent image upon the image bearing member into a visual image using a developer liquid in which developer particles have been dispersed within a liquid carrier, an intermediate transfer medium that makes contact with the image bearing member onto which the visual image upon the image bearing member is transferred, a transfer unit, having a backup member that makes contact with the intermediate transfer medium, the transfer unit transfers the visual image upon the intermediate transfer medium onto a transfer material by pressing the transfer material against the intermediate transfer medium using the backup member, a determination unit that determines the type of the transfer material onto which the visual image has been transferred by the transfer unit, and a control unit that variably controls the pressure exerted on the transfer material by the backup member in accordance with the type of the transfer material as determined by the determination unit.

When a roller having a concaved portion is used, fluctuations arising due to fluctuations in the load at the concaved portion, rotational unevenness arising due to eccentricity or wobbles in the roller, and so on are transmitted to the photosensitive member or the like, resulting in printing skew at the primary transfer portion of the photosensitive member, the exposure unit, or the like. In the case where this printing skew is not cyclic, it is difficult to properly control the alignment between the different colors, the alignment with respect to the paper, and so on.

### BRIEF SUMMARY OF THE INVENTION

A first aspect of the invention is an image forming apparatus comprising a latent image bearing drum on which a latent image is formed, an exposure unit that forms the latent image by exposing the latent image bearing drum, a developer unit that develops the latent image formed on the latent image bearing drum, a transfer medium onto which the image developed by the developer unit is transferred, and a transfer roller that transfers the image that has been transferred onto the transfer medium to the transfer material, the transfer roller including a roller base member having a concaved portion extending in the axial direction and a support portion disposed on an outer circumference of the roller base member, the support portion supporting the transfer material, wherein an imaginary rotational circumference of the support portion, which is equal to the outer circumference of the roller base member in the area where the concaved portion is not formed, is approximately an integral multiple of the circumference of the latent image bearing drum.

A second aspect of the invention comprises an image forming method comprising developing a latent image formed on a latent image bearing drum, transferring the image developed on the latent image bearing drum onto a transfer medium; and, transferring the image that has been transferred onto the transfer medium to a transfer material using a transfer roller including a roller base member having a concaved portion extending in the axial direction and a support portion disposed on an outer circumference of the roller that supports the transfer material, wherein an imaginary rotational circumference of the support portion, which is equal to the outer circumference of the roller base member in the area where the concaved portion is not formed, is approximately equal to an integral multiple of the circumference of the latent image bearing drum

In the image forming apparatus and image forming method according to the invention, the effective circumference of the transfer roller is set to an integral multiple or an approximate integral multiple of the circumference of the latent image bearing drum, which lends cyclicity to image unevenness caused by fluctuations in the load at the concaved portion, which enables those fluctuations to be predicted. This in turn makes it possible to respond to such fluctuations in the various types of controls that are carried out.

In addition, detecting the rotation position of the transfer roller in which the image unevenness actually occurs using the position detection portion makes it possible to determine the gripping position of the transfer roller, the position of the transfer roller itself, and so on, enabling favorable control to be carried out. Furthermore, the accuracy of image unevenness suppression can be increased by detecting the rotation position of the latent image bearing drum using the position detection portion and controlling the movement velocity of the latent image bearing drum so that the rotation position of the transfer roller matches the reference.

### BRIEF DESCRIPTION OF THE DRAWINGS

The invention will be described with reference to the accompanying drawings, wherein like numbers reference like elements.

FIG. 1 is a diagram illustrating the primary elements of an image forming apparatus according to an embodiment of the invention;

FIG. 2 is a perspective view of a secondary transfer roller used in an image forming apparatus according to an embodiment of the invention;

FIGS. 3A to 3D are diagrams illustrating operations performed by a transfer material gripping mechanism of a secondary transfer roller used in an image forming apparatus according to an embodiment of the invention;

FIG. 4 is a diagram illustrating operations performed by a transfer material transport unit used in an image forming apparatus according to an embodiment of the invention;

FIG. 5 is a diagram illustrating operations performed by a transfer material transport unit used in an image forming apparatus according to an embodiment of the invention;

FIG. 6 is a block diagram illustrating control blocks in an image forming apparatus according to an embodiment of the invention;

FIGS. 7A-7B are diagrams illustrating operations performed by a secondary transfer unit in an image forming apparatus according to an embodiment of the invention;

FIGS. 8A-8B are diagrams illustrating operations performed by a secondary transfer unit in an image forming apparatus according to an embodiment of the invention;

FIG. 9 is a diagram illustrating a relationship between the circumferential lengths of a secondary transfer roller and a developing roller in an image forming apparatus according to an embodiment of the invention;

FIG. 10 is a diagram illustrating the occurrence of image unevenness upon a secondary transfer roller, which is a problem addressed by the invention;

FIG. 11 is a diagram illustrating exposure timing in an image forming apparatus according to an embodiment of the invention;

FIG. 12 is a diagram illustrating a position detection portion of a secondary transfer roller in an image forming apparatus according to an embodiment of the invention;

FIG. 13 is a diagram illustrating exposure starting timing in an image forming apparatus according to an embodiment of the invention;

FIG. 14 is a diagram illustrating a configuration for performing phase alignment in an image forming apparatus according to an embodiment of the invention;

FIG. 15 is a diagram illustrating the phase situations of a photosensitive member and a secondary transfer roller in an image forming apparatus according to an embodiment of the invention;

FIG. 16 is a diagram illustrating a relationship between the circumferential lengths of a secondary transfer roller and a developing roller in an image forming apparatus according to another embodiment of the invention;

FIG. 17 is a diagram illustrating exposure timing in an image forming apparatus according to another embodiment of the invention;

FIG. 18 is a diagram illustrating a configuration for performing phase alignment in an image forming apparatus according to another embodiment of the invention;

FIG. 19 is a diagram illustrating the phase situations of a photosensitive member and a secondary transfer roller in an image forming apparatus according to another embodiment of the invention; and

FIG. 20 is a diagram illustrating the primary elements of an image forming apparatus according to another embodiment of the invention.

### DESCRIPTION OF EXEMPLARY EMBODIMENTS

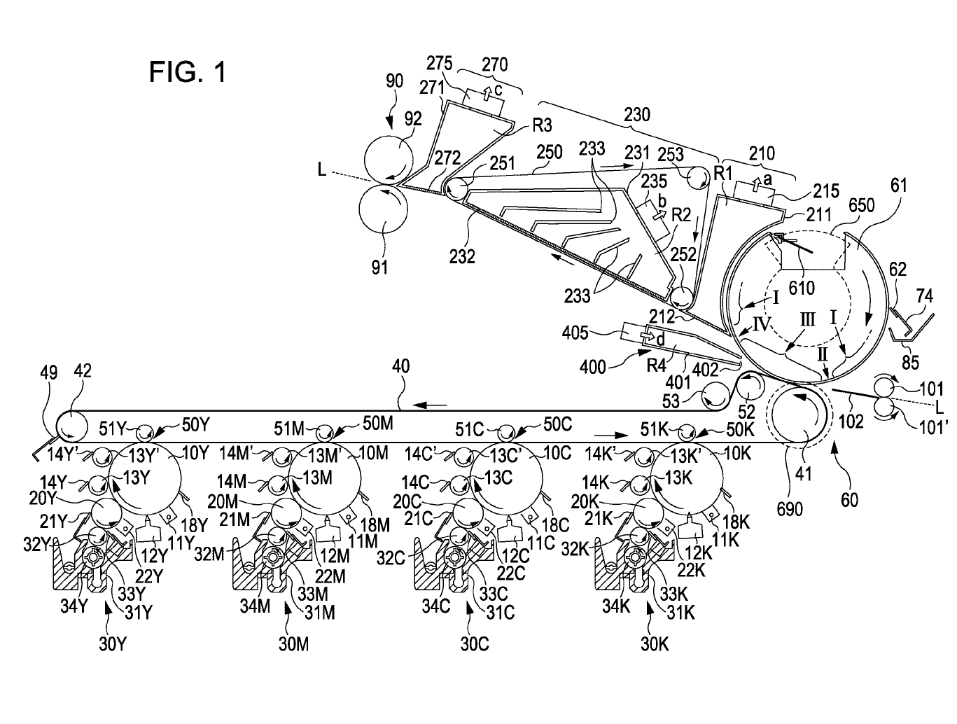

Embodiments of the invention will now be described with reference to the drawings. FIG. 1 is a diagram illustrating the primary elements of which an image forming apparatus according to an embodiment of the invention. Image forming units of respective colors are disposed in the central portion of the image forming apparatus. Developer units 30Y, 30M, 30C, and 30K are disposed in the lower portion of the image forming apparatus, and elements such as a transfer belt 40, a secondary transfer portion (secondary transfer unit) 60, a fixing unit 90, and so on are disposed in the upper portion of the image forming apparatus. In particular, the fixing unit 90 is disposed above the transfer belt 40, thereby making it possible to reduce the installation footprint of the image forming apparatus as a whole. In this embodiment, the configuration is such that a transfer material such as paper that has undergone a secondary transfer in the secondary transfer unit 60 is pulled by a transfer material transport device 230, suction units 210 and 270, and so on and then transported to the fixing unit 90, which makes it possible to realize such a layout.

The developer units (that is, the “developer unit” according to the invention) 30Y, 30M, 30C, and 30K, respectively, include photosensitive members 10Y, 10M, 10C, and 10K, corona charging units 11Y, 11M, 11C, and 11K, exposure units 12Y, 12M, 12C, and 12K, which are LED arrays or the like, and so on. The photosensitive members 10Y, 10M, 10C, and 10K are uniformly charged by the respective corona charging units 11Y, 11M, 11C, and 11K, and the exposure units 12Y, 12M, 12C, and 12K expose the respective photosensitive members based on an inputted image signal, causing latent images to be formed on the charged photosensitive members 10Y, 10M, 10C, and 10K.

Generally speaking, the developer units 30Y, 30M, 30C, and 30K include developing rollers 20Y, 20M, 20C, and 20K, developer reservoirs 31Y, 31M, 31C, and 31K that hold liquid developers of the colors yellow (Y), magenta (M), cyan (C), and black (K), anilox rollers 32Y, 32M, 32C, and 32K, respectively, that serve as application rollers for applying the liquid developers of the stated colors from the developer reservoirs 31Y, 31M, 31C, and 31K onto the developing rollers 20Y, 20M, 20C, and 20K. Then the electrostatic latent images formed upon the photosensitive members (latent image bearing drums) 10Y, 10M, 10C, and 10K are developed by the liquid developers of the stated colors.

The transfer belt 40 (transfer medium) is an endless belt that is stretched across a driving roller 41 and tension rollers 42, 52, and 53. The transfer belt 40 is rotationally driven by the driving roller 41 while making contact with the photosensitive members 10Y, 10M, 10C, and 10K at primary transfer sections 50Y, 50M, 50C, and 50K. The primary transfer sections 50Y, 50M, 50C, and 50K form a full-color toner image by sequentially transferring the developed toner images of the stated colors upon the photosensitive members 10Y, 10M, 10C, and 10K onto the transfer belt 40 at the transfer position of the contact position with the photosensitive members 10Y, 10M, 10C, and 10K. The photosensitive members 10Y, 10M, 10C, and 10K are disposed opposite to the primary transfer rollers 51Y, 51M, 51C, and 51K, with the transfer belt 40 being disposed between the primary transfer rollers and the photosensitive members.

In the secondary transfer unit 60, a secondary transfer roller 61 is disposed opposite to the belt driving roller 41 with the transfer belt 40 being disposed therebetween. Furthermore, a cleaning unit comprising a secondary transfer roller cleaning blade 62 is provided as well. A single-color toner image, a full-color toner image, or the like formed upon the transfer belt 40 is transferred onto a transfer material such as paper, film, cloth, or the like that is transported along a transfer material transport path L, at a transfer position located where the secondary transfer roller 61 is disposed.

Furthermore, a first suction unit 210, a transfer material transport device 230, and a second suction unit 270 are arranged in that order downstream from the transfer material transport path L. The transfer material is thus transported to the fixing unit 90, where the single-color toner image, full-color toner image, or the like transferred onto the transfer material is fused and fixed to the transfer material.

The transfer belt 40 is stretched across the tension roller 42, the belt driving roller 41, and so on. A cleaning unit comprising a transfer belt cleaning blade 49 is disposed at the location where the transfer belt 40 is stretched across the tension roller 42, and makes contact with the transfer belt 40, thereby cleaning residual toner, carrier, or the like from the surface of the transfer belt 40. Note that it is also possible to allocate the driving force for driving the transfer belt 40 to the tension roller 42 and use the belt driving roller 41 as a simple belt support roller.

The transfer material is supplied to the image forming apparatus by a paper supply unit (not shown). The transfer material set in such a paper supply unit is transported along the transfer material transport path L on a sheet-by-sheet basis at a predetermined timing. In the transfer material transport path L, the transfer material is transported to a secondary transfer position by gate rollers 101 and 101′ and a transfer material guide 102, whereupon a single-color developed toner image, a full-color developed toner image, or the like formed upon the transfer belt 40 is transferred onto the transfer material. The transfer material that has undergone the secondary transfer is then transported to the fixing unit 90 by a transfer material transport unit whose central element is the transfer material transport device 230, as described above. The fixing unit 90 is configured of a heating roller 91 and a pressure roller 92 that is biased toward the heating roller 91 at a predetermined pressure. The transfer material is inserted into the nipping point between these rollers, and the single-color toner image, full-color toner image, or the like transferred, fused, and fixed upon the transfer material.

The developer units will be described hereinafter, but because the configurations of the image forming units and developer units are identical for each of the stated colors, the following descriptions will be given based on the yellow (Y) image forming unit and developer unit.

The corona charging unit 11Y, the exposure unit 12Y, the developing roller 20Y of the developer unit 30Y, a first photosensitive member squeeze roller 13Y, a second photosensitive member squeeze roller 13Y′, the primary transfer section 50Y, a discharge unit (not shown), and a photosensitive member cleaning blade 18Y are disposed in the image forming unit following the rotational direction of the external circumference of the photosensitive member 10Y, with elements disposed in earlier stages defined as being upstream from elements disposed in later stages.

The photosensitive member cleaning blade 18Y that makes contact with the photosensitive member 10Y downstream from the primary transfer section 50Y cleans liquid developer rich in carrier components from the surface of the photosensitive member 10Y.

A cleaning blade 21Y, the anilox roller 32Y, and a compaction corona generator 22Y are disposed around the outer surface of the developing roller 20Y in the developer unit 30Y. A regulation blade 33Y that adjusts the amount of liquid developer supplied to the developing roller 20Y makes contact with the anilox roller 32Y. An auger 34Y is contained within the liquid developer reservoir 31Y. Meanwhile, the primary transfer roller 51Y of the primary transfer unit is disposed in a position opposite to the photosensitive member 10Y, with the transfer belt 40 being disposed therebetween.

The photosensitive member 10Y is a photosensitive drum comprising a cylindrical member, with a photosensitive layer such as an amorphous silicon photosensitive material formed on the external circumference thereof. The photosensitive member 10Y rotates in the clockwise direction.

The corona charging unit 11Y is disposed upstream in the rotational direction of the photosensitive member 10Y from the nipping portion formed between the photosensitive member 10Y and the developing roller 20Y. A voltage is applied from a power source unit (not shown), thereby charging the photosensitive member 10Y with a corona discharge. The exposure unit 12Y is downstream from the corona charging unit 11Y in the rotational direction of the photosensitive member 10Y. The exposure unit 12Y irradiates the surface of the photosensitive member 10Y that has been charged by the corona charging unit 11Y with light, thereby forming a latent image upon the photosensitive member 10Y. Note that from the beginning to the end of the image forming process, elements such as rollers disposed in earlier stages are defined as being upstream from elements such as rollers disposed in later stages.

The developer unit 30Y includes the compaction corona generator 22Y that has a compaction effect, and the developer reservoir 31Y that holds liquid developer in a state in which the toner within the carrier is dispersed at a weight ratio of approximately 20%.

Furthermore, the developer unit 30Y includes the developing roller 20Y that holds the stated liquid developer, the anilox roller 32Y, which is an application roller for applying the liquid developer to the developing roller 20Y, the regulation blade 33Y that regulates the amount of liquid developer applied to the developing roller 20Y, the auger 34Y that supplies the liquid developer to the anilox roller 32Y while agitating and transporting the liquid developer, the compaction corona generator 22Y that places the liquid developer held on the developing roller 20Y into a state of compaction, and the developing roller cleaning blade 21Y that cleans the developing roller 20Y.

The liquid developer held in the developer reservoir 31Y is a non-volatile liquid developer, which is non-volatile at normal temperatures, and which has a high concentration and high viscosity, rather than a volatile liquid developer that uses Isopar (an Exxon brand) as its carrier, which is volatile at normal temperatures, has a low concentration (approximately 1-2 wt %), and that has a low viscosity, as has generally been used in the past. In other words, the liquid developer in the invention is a high-viscosity liquid developer (that is, a viscoelasticity of approximately 30 to 300 mPa·s at a shear rate of 1000 (1/s) at 25° C., measured using a HAAKE RheoStress RS600) with a toner solid content concentration of 20%, in which solid particles of a colorant such as a pigment having an average particle diameter of 1 μm are dispersed within a thermoplastic resin and are added to a liquid carrier such as an organic carrier, silicon oil, mineral oil, or cooking oil along with a dispersant.

The anilox roller 32Y functions as an application roller that supplies and applies liquid developer to the developing roller 20Y. The anilox roller 32Y is a cylindrical member, and is a roller whose surface is formed as a non-planar surface by engraving minute channels in a uniform helical pattern in that surface so as to make it easier for the surface to hold developer. The liquid developer is supplied from the developer reservoir 31Y to the developing roller 20Y by this anilox roller 32Y. As shown in FIG. 1, when the apparatus is operating, the auger 34Y rotates in the counterclockwise direction, supplying the liquid developer to the anilox roller 32Y. The anilox roller 32Y, meanwhile, rotates in the counterclockwise direction, and applies the liquid developer to the developing roller 20Y.

The regulation blade 33Y is an elastic blade configured with an elastic member covering the surface thereof, and is configured of a rubber portion made up of urethane rubber or the like that makes contact with the surface of the anilox roller 32Y. The regulation blade 33Y adjusts the amount of liquid developer supplied to the developing roller 20Y by regulating and adjusting the film thickness and amount of the liquid developer held and transported by the anilox roller 32Y.

The developing roller cleaning blade 21Y is configured of rubber or the like that makes contact with the surface of the developing roller 20Y. The developing roller cleaning blade 21Y is disposed downstream in the rotational direction of the developing roller 20Y from a developing nip portion formed where the developing roller 20Y and the photosensitive member 10Y make contact with each other. The developing roller cleaning blade 21Y removes residual liquid developer from the developing roller 20Y.

The compaction corona generator 22Y is an electrical field application unit that increases the charge bias on the surface of the developing roller 20Y. An electrical field is applied from the compaction corona generator 22Y towards the developing roller 20Y by the compaction corona generator 22Y at a compaction position. Note that the electrical field application unit for this compaction may employ a compaction roller, rather than employing a corona discharge from a corona discharge unit as shown in FIG. 1.

The developer held on the developing roller 20Y that has undergone compaction is developed in correspondence with the latent image on the photosensitive member 10Y by a predetermined electrical field being applied at the developing nipping portion where the developing roller 20Y and the photosensitive member 10Y make contact with each other.

The developer remaining after this developing is wiped off and removed by the developing roller cleaning blade 21Y. The removed developer drops into a collection receptacle within the developer reservoir 31Y, and is reused. Note that the carrier and toner reused in this manner are not in a mixed-color state.

A photosensitive member squeeze unit disposed upstream from the primary transfer position is disposed downstream from the developing roller 20Y and opposite to the photosensitive member 10Y. The photosensitive member squeeze unit collects the residual carrier of the developed toner image that remains on the photosensitive member 10Y. This photosensitive member squeeze unit comprises the first photosensitive member squeeze roller 13Y and the second photosensitive member squeeze roller 13Y′, both of which are elastic roller members that rotate while sliding on the photosensitive member 10Y. The photosensitive member squeeze unit has a function for collecting residual carrier and originally unnecessary fog toner from the toner image developed upon the photosensitive member 10Y, thereby increasing the toner particle ratio within the visualized image (toner image). Note that a predetermined bias voltage is applied to the photosensitive member squeeze rollers 13Y and 13Y′.

Having passed the squeeze unit comprising the first photosensitive member squeeze roller 13Y and the second photosensitive member squeeze roller 13Y′ mentioned above, the surface of the photosensitive member 10Y proceeds to the primary transfer section 50Y.

At the primary transfer section 50Y, the developer image developed on the photosensitive member 10Y is transferred to the transfer belt 40 by the primary transfer roller 51Y. Furthermore, at the primary transfer section, the toner image upon the photosensitive member 10Y is transferred onto the transfer belt 40 due to the effects of the transfer bias applied to the primary transfer backup roller 51Y. Here, the configuration is such that the photosensitive member 10Y and the transfer belt 40 move at the same velocity thereby reducing the driving burden for rotation and movement as well as suppressing disturbances to the visualized toner image on the photosensitive member 10Y.

Magenta (M), cyan (C), and black (K) toner images are formed upon the photosensitive members 10M, 10C, and 10K, respectively, in the respective developer units 30M, 30C, and 30K, through the same process as the aforementioned developing process of the developer unit 30Y. The transfer belt 40 passes through the nipping points of the primary transfer sections 50 for the colors yellow (Y), magenta (M), cyan (C), and black (K), whereby the developer (developed images) upon the photosensitive members for each color are transferred thereto and superimposed upon each other as a result. The transfer belt 40 then enters into the nipping portion of the secondary transfer unit 60.

Having passed the secondary transfer unit 60, the transfer belt 40 makes another pass in order to pick up a transfer image at the primary transfer sections 50, but the transfer belt 40 is cleaned by the transfer belt cleaning blade 49 and so on upstream from the primary transfer sections 50.

The transfer belt 40 has a three-layer structure, in which a polyurethane elastic intermediate layer is provided upon a polyimide base layer, and a PFA surface layer is provided thereupon. This transfer belt 40 is used in a state in which it is stretched across the belt driving roller 41 and the tension rollers 42, 52, and 53, and the toner images are transferred on the side of the PFA surface layer.

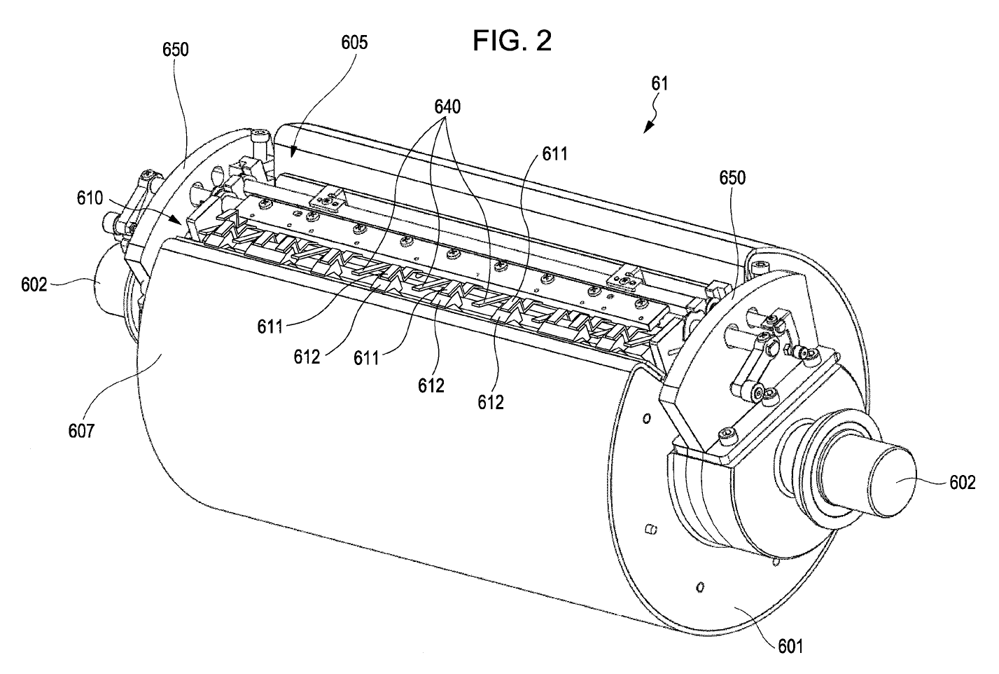

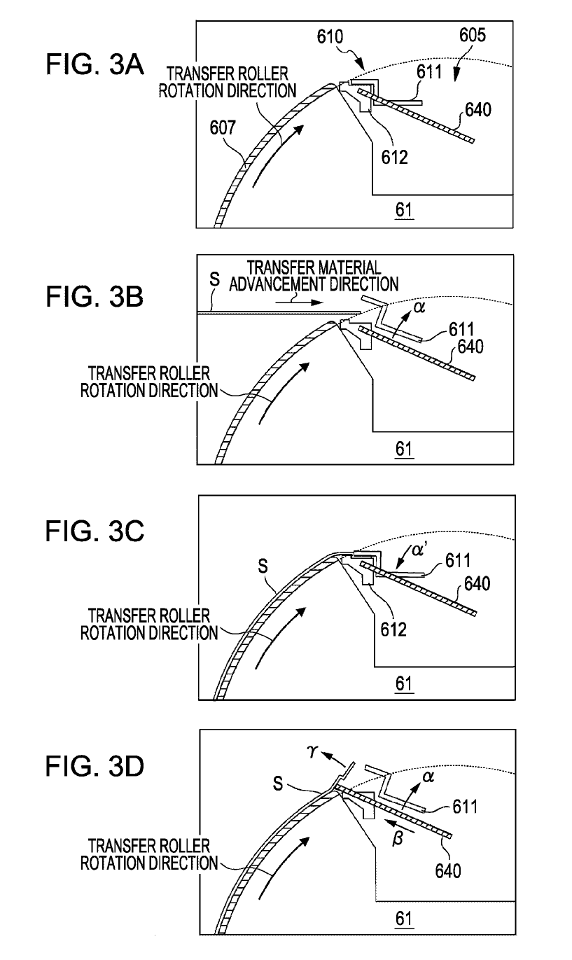

Next, the secondary transfer roller 61 used in the image forming apparatus according to this embodiment will be described in detail. FIG. 2 is a perspective view of the secondary transfer roller used in the image forming apparatus according to this embodiment of the invention, and FIGS. 3A to 3D are diagrams illustrating operations performed by a transfer material gripping mechanism of the secondary transfer roller. In FIGS. 2 and 3A-3D, the apparatus includes a roller base member 601, a roller shaft portion 602, an open concaved portion 605, an elastic member 607, a transfer material gripping mechanism 610, transfer material gripping portions 611, transfer material gripping portion receiving portions 612, transfer material detaching members 640, and contact members 650.

The roller shaft portions 602 are provided on both sides of the roller base member 601 of the secondary transfer roller 61, and the secondary transfer roller 61 is attached to the main body of the apparatus so as to be rotatable central to the roller shaft portion 602. Furthermore, the open concaved portion 605 is provided in the roller base member 601 spanning in the axial direction thereof. The transfer material gripping mechanism 610 is provided within the open concaved portion 605, and the elastic member 607 (support portion), which supports the transfer material, is provided on the roller base member 601 adjacent to the open concaved portion 605. The transfer material gripping mechanism 610 is a mechanism for gripping and releasing the transfer material. The elastic member 607 is a semi-conductive elastic rubber layer having an electrically-resistive component, and, in a state where the transfer material is wrapped upon the elastic member 607, transfers a toner image from the transfer belt 40 onto the transfer material when the transfer material passes through a secondary transfer nipping point of the secondary transfer unit 60.

Generally speaking, the transfer material gripping mechanism 610 is configured of pairs of transfer material gripping portions 611 and transfer material gripping portion receiving portions 612 (gripping member) provided discretely across the axial direction of the roller, and multiple transfer material detaching members 640 disposed as appropriate across the axial direction of the roller between the stated pairs. Each of the transfer material gripping portions 611 is configured so as to be capable of movement, and is capable of gripping the transfer material by operating so as to grip the transfer material with the corresponding transfer material gripping portion receiving portion 612, releasing the transfer material by operating so as to open up a space with the corresponding transfer material gripping portion receiving portion 612, and so on. In addition, each of the transfer material detaching members 640 operates so as to push the transfer material that has been gripped by the transfer material gripping portions 611 and the transfer material gripping portion receiving portions 612 in the direction away from the secondary transfer roller 61.

Two contact members 650 are provided on the roller shaft portions 602, each on either side of the secondary transfer roller 61. These contact members 650 are structured so as to have a contact surface in a region corresponding to the open region in which the open concaved portion 605 is provided in the secondary transfer roller 61 when viewed along the axial direction of the roller. The position between the secondary transfer roller 61 and the belt driving roller 41 is regulated by this contact surface coming into contact with a contacted member, which will be described more fully below.

Operations of the transfer material gripping mechanism 610 will be described in more detail with reference to FIGS. 3A to 3D. FIGS. 3A to 3D are schematic diagrams illustrating the various elements of the transfer material gripping mechanism 610 along the axial direction. The states of the transfer material gripping mechanism 610 illustrated in FIGS. 3A, 3B, 3C, and 3D roughly illustrate the respective operational states that the transfer material gripping mechanism 610 assumes when the transfer material gripping mechanism 610 of the secondary transfer roller 61 reaches the locations of the secondary transfer roller 61 marked with I, II, III, and IV in FIG. 1.

FIG. 3A illustrates a state in which the transfer material gripping mechanism 610 is not gripping the transfer material, and the secondary transfer roller 61 is rotating. At this time, the transfer material gripping portion 611 and the transfer material detaching members 640 are located within the outermost circumference of the secondary transfer roller 61 when that roller is viewed as a cylinder. This corresponds to a state in which the transfer material gripping mechanism 610 is present in the range indicated by I in FIG. 1, during the rotation of the secondary transfer roller 61.

FIG. 3B is a diagram illustrating a state in which the transfer material gripping portions 611 move in the direction indicated by α, forming a predetermined space between themselves and the transfer material gripping portion receiving portions 612, thereby preparing to grip a transfer material S that advances into that space between the transfer material gripping portions 611 and the transfer material gripping portion receiving portions 612. This corresponds to a state during the rotation of the secondary transfer roller 61 in which the transfer material gripping mechanism 610 has proceeded to the location II illustrated in FIG. 1, and preparation is made to grip the transfer material that is advancing along the transfer material guide 102 as a result of the rotation of the gate rollers 101 and 101′.

FIG. 3C illustrates a state in which the transfer material gripping portions 611 move in the direction indicated by α′, thereby gripping the transfer material S that has advanced into the stated space between themselves and the transfer material gripping portion receiving portions 612. At this time, the transfer material S, one end of which is gripped by the transfer material gripping mechanism 610, is in a state in which it is wrapped upon the roller base member 601 of the secondary transfer roller 61 as a result of the rotation of the secondary transfer roller 61. In this manner, the positioning of the transfer material S onto which a toner image has been transferred can be carried out in a stringent manner by gripping/securing the transfer material S with the transfer material gripping mechanism 610 in a stage prior to the transfer material advancing into the secondary transfer nipping point. During the rotation of the secondary transfer roller 61, the state shown in FIG. 3C is maintained while the transfer material gripping mechanism 610 is located in the range of III illustrated in FIG. 1.

FIG. 3D illustrates a state in which the transfer material gripping portions 611 move in the direction indicated by α, forming a predetermined space between themselves and the transfer material gripping portion receiving portions 612 and thus releasing the transfer material S, whereupon the transfer material detaching members 640 move in the direction indicated by α′, pushing the transfer material S in the direction away from the secondary transfer roller 61. This operational state occurs when, during the rotation of the secondary transfer roller 61, the transfer material gripping mechanism 610 reaches the position indicated by IV in FIG. 1, and the transfer material S that has passed through the secondary transfer nip and onto which a toner image has been transferred is passed on to the transfer material transport process, which follows thereafter.

As described thus far, the transfer material gripping mechanism 610 operates so as to grip the transfer material S before the transfer material S enters into the secondary transfer nip between the transfer belt 40 and the secondary transfer roller 61 and release the gripped transfer material S after the transfer material S has passed through the secondary transfer nip between the transfer belt 40 and the secondary transfer roller 61. By the transfer material gripping mechanism 610 performing the operations illustrated in FIG. 3D, it is possible to detach the transfer material S that has passed through the secondary transfer nipping point from the secondary transfer roller 61 with certainty and to guide that transfer material S to the transfer material transport process that follows thereafter with certainty as well. Furthermore, unlike the cases that currently arise in the art where an image formation process results in the transfer material S adheres to the secondary transfer roller 61 or the transfer belt 40 and it is difficult to detach the transfer material S, the transfer member gripping mechanism 610 of the present invention ensures that the transfer material S can be detached from the various elements with certainty.

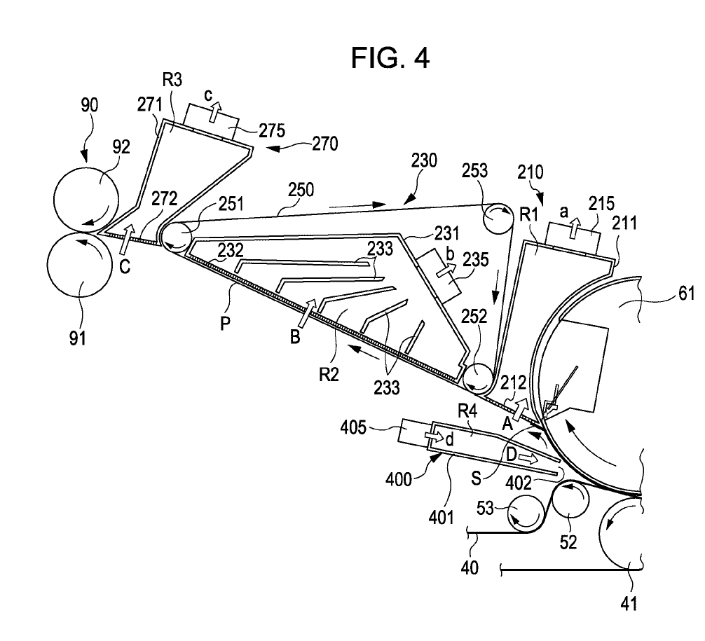

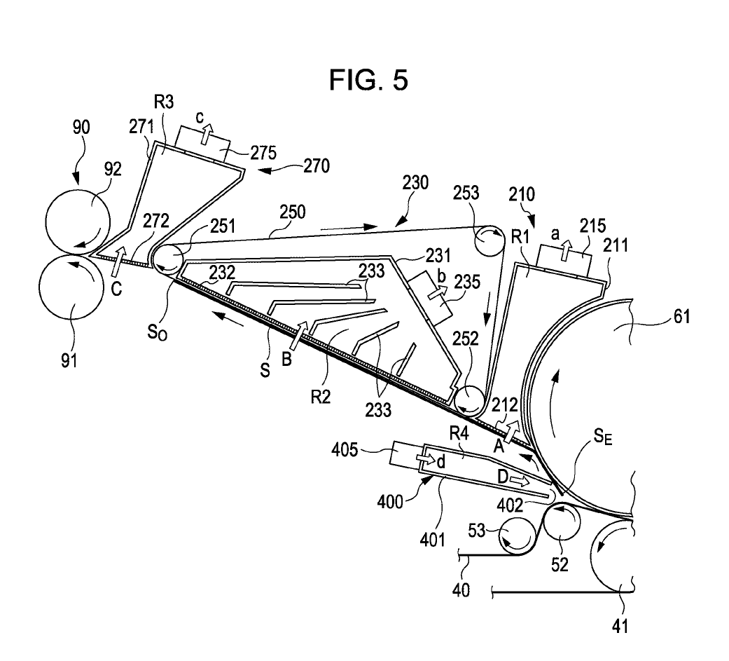

The transfer material S that has been released from the transfer material gripping mechanism 610 as described above is then transported to the fixing unit 90. A transport unit for carrying out this transport will be described next. FIGS. 4 and 5 are diagrams illustrating operations performed by a transfer material transport unit used in the image forming apparatus according to this embodiment of the invention. In FIGS. 4 and 5, the apparatus includes a first suction unit 210, a housing portion 211, a suction surface 212, an airflow production unit 215, a transfer material transport device 230, a housing portion 231, a suction surface 232, partition members 233, an airflow production unit 235, a transfer material transport member 250, a transfer material transport member driving roller 251, transfer material transport member support rollers 252 and 253, a second suction unit 270, a housing portion 271, a suction surface 272, an airflow production unit 275, a blowing unit 400, a housing portion 401, an opening portion 402, and an airflow production unit 405.

The first suction unit 210 includes the housing portion 211 in which the airflow production unit 215, which is a sirocco fan or the like, is provided. Due to this airflow production unit 215, air can be discharged from a space R1 within the housing unit 211 to the exterior of the housing unit 211. The bottom surface of the housing portion 211 is the suction surface 212, in which multiple vent holes are provided across the surface. The first suction unit 210 operates the airflow production unit 215, thereby causing air to be discharged to the exterior of the housing portion 211 as indicated by “a” in FIGS. 4 and 5, thereby generating a suction force as indicated by “A” in FIGS. 4 and 5. As a result of this suction force, the transfer material S onto which a toner image has been transferred resists gravity and is held upon the suction surface 212. This suction force is of a degree that enables the transfer material S to be held on the suction surface 212, but is not of a degree that causes the transfer material S to resist being pressed from the secondary transfer nipping point, which would impede the advancement of the transfer material S.

The transfer material transport device 230 is generally comprised of the housing unit 231 in which the airflow production unit 235, which is a sirocco fan or the like, is provided, the transfer material transport member 250, which is disposed around the periphery of the housing unit 231, and so on. With the transfer material transport device 230, due to the airflow production unit 235, air can be discharged from a space R2 within the housing unit 231 to the exterior of the housing unit 231.

The bottom surface of the housing portion 231 is the suction surface 232, in which multiple vent holes are provided. A suction force is produced at the suction surface 232 as indicated by “B” in FIGS. 4 and 5 as a result of the air discharge effect caused by the airflow production unit 235, indicated by “b” in FIGS. 4 and 5. At this time, due to the effects of the partition members 233 disposed within the housing unit 231, air is discharged from the space R2 within the housing portion 231 in a comparatively uniform manner, thereby ensuring that imbalances in the suction force at the suction surface 232 do not occur from location to location.

The transfer material transport member 250 disposed in the periphery of the housing portion 231 is an endless belt in which multiple vent through holes (not shown) are provided. The transfer material transport member 250 is stretched across the transfer material transport member driving roller 251, which provides a driving force to the transfer material transport member 250, and the transfer material transport member support rollers 252 and 253. The transfer material transport member 250 moves in the direction of the arrow shown in FIGS. 4 and 5 as a result of the rotation of the transfer material transport member driving roller 251, and the movement velocity thereof is approximately the same as the velocity of the image formation process. The length of the transfer material transport member 250 in the axial direction (or width of the transfer material transport member 250) is set so as to be greater than the width of the transfer material having the maximum width that can be handled by the image forming apparatus.

The suction force at the suction surface 232 of the housing portion 231 also acts through the vent holes of the transfer material transport member 250, and thus the transfer material S onto which a toner image has been transferred resists gravity and is held on a transport surface P of the transfer material transport member 250. The transfer material S is also transported along the transport surface P as a result of the movement of the transfer material transport member 250 caused by the driving force of the transfer material transport member driving roller 251. The region of the transfer material transport member 250 spanning from the transfer material transport member support roller 252 to the transfer material transport member driving roller 251 is used as the transport surface P for transporting the transfer material S.

The second suction unit 270 includes the housing portion 271 in which the airflow production unit 275, which is a sirocco fan or the like, is provided. Due to this airflow production unit 275, air can be discharged from a space R3 within the housing unit 271 to the exterior of the housing unit 271. The bottom surface of the housing portion 271 is the suction surface 272, in which multiple vent holes are provided across the surface. An suction force is produced as indicated by “C” in FIGS. 4 and 5 as a result of the air discharge effect caused by the airflow production unit 275 of the second suction unit 270, indicated by “c” in FIGS. 4 and 5. As a result of this suction force, the transfer material S onto which a toner image has been transferred resists gravity and is held upon the suction surface 272. This suction force is of a degree that enables the transfer material S to be held on the suction surface 272, but is not of a degree that causes the transfer material S to resist the pressure involved with the transport, which would impede the transport of the transfer material S.

The transfer material transport unit according to this embodiment, comprised of the first suction unit 210, the transfer material transport device 230, the second suction unit 270, and so on transports the transfer material onto which the toner image has been transferred with the image facing downward.

The blowing unit 400 expels air into the space between the transfer belt 40 and the secondary transfer roller 61 in the vicinity of the secondary transfer nip, and using the airflow production unit 405, which is a sirocco fan or the like, air is delivered into a space R4 within the housing portion 401. The opening portion 402 is provided in this housing portion 401 spanning across the axial direction of the rollers, and the air delivered into the housing portion 401 by the airflow production operations performed by the airflow production unit 405, indicated by “d” in FIGS. 4 and 5, is expelled from this opening portion 402 as indicated by “D” in FIGS. 4 and 5. The expulsion force of the air at this time is adjusted to a degree whereby the transfer material S onto which the toner image has been transferred resists gravity and does not sag in the downward direction, and a degree whereby the transfer material S does not flap due to the force of the air.

Next, the operation of the transfer material transport unit of this embodiment will be described. FIG. 4 illustrates a state immediately after the transport direction leading edge (SO) of the transfer material S has been discharged from the secondary transfer nipping point of the secondary transfer unit 60, or in other words, immediately after the transfer material S has been passed from the secondary transfer unit 60 to the transfer material transport unit. As shown in FIG. 4, the transfer material S is transported by the force of delivery from the secondary transfer unit 60 so as to slide along the suction surface 212 while being held by the suction surface 212, without falling, by a suction force “A” of the suction surface 212 generated due to the operation of the airflow production unit 215, illustrated as “a”. At this time, the surface of the transfer material S that is sucked by the suction surface 212 is not the surface on which the toner image is formed through the secondary transfer operations immediately before, and thus the unfixed toner image is not disturbed by the transport operations performed by the transport unit. Furthermore, in this embodiment, providing the first suction unit 210 makes it possible to maintain the discharge attitude of the transfer material S in a stable manner, and as a result it is possible to prevent the toner image formation surface of the transfer material S from making contact with members such as the transfer belt 40 that are located below the transfer material S in the direction of the gravitational pull, which in turn prevents the unfixed toner image from being disturbed. Moreover, the first suction unit 210 that sucks the transfer material S is present between the secondary transfer roller 61 and the transfer material transport device 230, and therefore the attitude of the transfer material can be aligned with the air suction after the leading edge of the transfer material has detached from the belt, the secondary transfer roller 61, or the like, which in turn makes it possible to stabilize the attitude of the transfer material.

When, as a result of the force of the operation for delivering the transfer material S from the secondary transfer unit 60, the transport direction leading edge of the transfer material S, which has been transported while sliding along the suction surface 212 of the first suction unit 210, reaches the transfer material transport device 230, the transfer material S is held by a suction force B occurring at the transport surface P of the transfer material transport member 250 and advances along the transport surface P toward the fixing unit 90 as a result of the movement operations performed by the transfer material transport member 250.

FIG. 5 illustrates a state immediately following the transport direction following edge (SE) of the transfer material S being discharged from the secondary transfer nipping point of the secondary transfer unit 60. In particular, causing the blowing unit 400 to operate at this time and expel air as indicated by “D” makes it possible to prevent the following edge (SE) of the transfer material S from coming into contact with the transfer belt 40 or the like when the following edge (SE) of the transfer material S is discharged from the secondary transfer nip, which can cause the image to become soiled.

In this embodiment, the blowing unit 400 that expels air into the nipping exit space between the secondary transfer roller 61 and the transfer belt 40 as described above is provided, and therefore the transfer material following edge (SE) can be pressed toward the secondary transfer roller 61 even after the transfer material following edge (SE) has been discharged from the secondary transfer nipping point, which makes it possible to stabilize the attitude of the transfer material S after the transfer material S has been discharged from the secondary transfer nipping point.

The transfer material S shown in FIG. 5 is, when viewed in the transport direction, is a transfer material of the maximum length that can be handled by the apparatus. With the image forming apparatus according to this invention, the dimensions of the various elements are set so that the transfer material S is not gripped by both a fixing nipping point of the fixing unit 90 and the secondary transfer nipping point of the secondary transfer unit 60 at the same time, even when a transfer material of the maximum length is used. Accordingly, even if there is a difference between the fixing unit 90 and the secondary transfer unit 60 in the velocity at which the transfer material S is transported, the transfer material S does not sag and is not stretched, thus making it possible to avoid negative influence on the image and the like.

Furthermore, even if there is a difference between the transport velocity of the secondary transfer unit 60 and the transport velocity of the transfer material transport member 250 when the transfer material S is gripped by the secondary transfer nipping point of the secondary transfer unit 60 while being transported along the transport surface P of the transfer material transport device 230, the transfer material S held by the transfer material transport member 250 is held only by the suction force of the air; therefore, the transfer material S can slide along the transfer material transport member 250, and thus does not sag, is not stretched, and so on.

Similarly, even if there is a difference between the transport velocity of the fixing unit 90 and the transport velocity of the transfer material transport member 250 when the transfer material S is gripped by the fixing nipping point of the fixing unit 90 and is being transported along the transport surface P of the transfer material transport device 230, the transfer material S can slide along the transfer material transport member 250, and thus does not sag, is not stretched, and so on.

In this manner, the transfer material transport device 230 is capable of functioning as a mechanism that absorbs differences in the velocities at which the various units transport the transfer material S.

The transfer material S transported along the transport surface P of the transfer material transport device 230 passes the suction surface 272 of the second suction unit 270, and in the fixing unit 90, advances into the fixing nipping point formed by the heating roller 91 and the pressure roller 92. The toner image is fused to the transfer material S that has passed through this fixing nipping point, resulting in a permanent visible image.

With image forming methods that use liquid developer currently known in the art, a phenomenon in which providing a predetermined amount of time following the secondary transfer performed in the secondary transfer unit 60 enables a favorable fixing effectiveness to be achieved in the fixing unit 90 sometimes occurs. This is because providing a predetermined amount of time makes it possible for carrier that interferes with the fixing to be absorbed into the transfer material. If the layout is such that the fixing unit 90 is provided immediately after the secondary transfer unit 60, there is the concern that toner will be transferred onto the transfer material S by the secondary transfer unit 60 and that toner will then be immediately fixed, leading to a drop in the fixing effectiveness. One advantage of the image forming apparatus of the invention, however, is that the layout is such that a transport unit configured of the first suction unit 210, the transfer material transport device 230, the second suction unit 270, and the like is provided between the secondary transfer unit 60 and the fixing unit 90, and therefore the time involved in transporting the transfer material S makes it possible to obtain a predetermined amount of time after the secondary transfer and before the fixing process, thus achieving a favorable fixing effectiveness in the fixing unit 90.

Furthermore, with the image forming apparatus according to the invention, the first suction unit 210 that sucks the transfer material S discharged from the secondary transfer unit 60 is provided, which enables the transfer material S to be discharged into a space above the transfer belt 40 after the secondary transfer and enables the fixing unit 90 to be disposed using that space. Accordingly, there is an additional effect in that the installation footprint of the apparatus can be reduced.

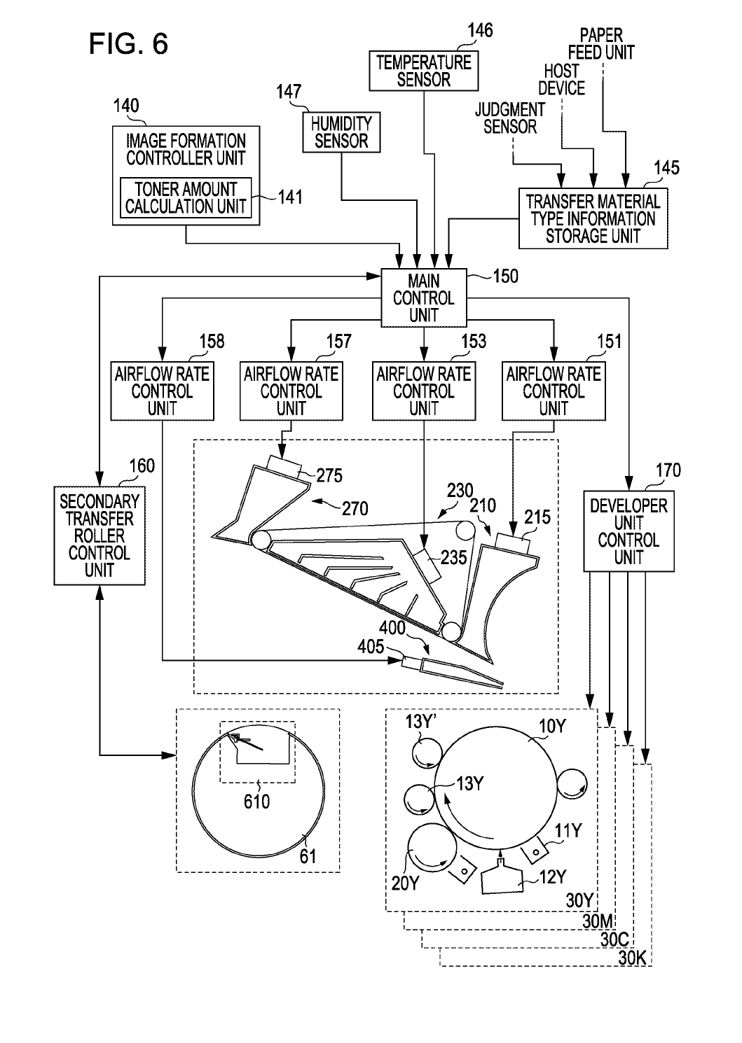

Next, control of the image forming apparatus according to the invention will be described. FIG. 6 is a block diagram illustrating the control of the image forming apparatus according to this embodiment of the invention. In FIG. 6, the apparatus includes an image formation controller unit 140, a toner amount calculation unit 141, a transfer material type information storage unit 145, a temperature sensor 146, a humidity sensor 147, a main control unit 150, airflow rate control units 151, 153, 157, and 158, a secondary transfer roller control unit 160, and a developer unit control unit 170.

The main control unit 150 is a main controller for performing various types of control of the image forming apparatus according to the invention. A generic information processing device provided with a CPU, a RAM, a ROM, and the like can be used as the main control unit 150, and operations for outputting commands to predetermined blocks based on inputted predetermined information can be realized by pre-storing programs to be executed by the CPU in the ROM.

The transfer material type information storage unit 145 is a storage unit that temporarily stores data regarding the types of transfer materials on which images are formed by the image forming apparatus. This transfer material type information storage unit 145 is configured so as to acquire, for example, information from a judgment sensor provided within the image forming apparatus that judges the type of the transfer material, information from a host device that outputs image formation execution commands to the image forming apparatus, or information from a paper feed unit that supplies the transfer material to the image forming apparatus, and then stores that information. The transfer material type data stored in the transfer material type information storage unit 145 is used as appropriate for control performed by the main control unit 150.

The temperature sensor 146 and the humidity sensor 147 are provided in appropriate locations within the image forming apparatus. These sensors are configured so as to acquire data regarding temperature and humidity, respectively, and send that data to the main control unit 150. Having received this data, the main control unit 150 outputs necessary control commands based on that data. Note that when configuring the image forming apparatus, both the temperature sensor 146 and humidity sensor 147 may be provided, or the configuration may be such that only one of these sensors is provided.

The image formation controller unit 140 controls the exposure performed by the exposure units 12Y, 12M, 12C, and 12K based on image signals inputted to the image forming apparatus. This image formation controller unit 140 is further provided with a toner amount calculation unit 141 that calculates the expected amount of toner to be used during image formation based on the exposure amount, exposure timing, and so on. The amount of toner to be transferred onto the entire transfer material S can thus be estimated by the toner amount calculation unit 141. Data regarding the toner amount calculated by the toner amount calculation unit 141 is transmitted to the main control unit 150. Having received this data, the main control unit 150 outputs control commands based on that data as appropriate.

The airflow rate control units 151, 153, 157, and 158 control the airflow rates during airflow production by the airflow production unit 215 of the first suction unit 210, the airflow production unit 235 of the transfer material transport device 230, the airflow production unit 275 of the second suction unit 270, and the airflow production unit 405 of the blowing unit 400, respectively. To be more specific, the airflow rate control units are controllers that control the velocity of motors provided for fans that function as the respective airflow production units. The main control unit 150 controls the rate of the airflow produced by the respective airflow production units by outputting control commands to the airflow rate control units 151, 153, 157, and 158. Through this, it is possible to freely control the suction force exerted on the transfer material, the amount of air discharged against the transfer material, or the like. Note that although this embodiment describes an example in which the airflow rate is controlled by controlling the motor of the fans, the configuration may be such that openable/closable ducts are provided within each housing portion and the airflow rate is controlled by opening/closing those ducts.

The secondary transfer roller control unit 160 controls the rotational circumferential velocity of the secondary transfer roller 61, the timing at which the transfer material gripping portions 611 in the transfer material gripping mechanism 610 operate, the timing at which the transfer material separation members 640 operate, and so on, based on control commands from the main control unit 150. The secondary transfer roller control unit 160 is also used for various types of controls performed when a rotation reference position of the secondary transfer roller 61 detected by a rotation position detection portion is communicated to the main control unit 150. With the secondary transfer roller control unit 160, it is possible to freely change the timing at which the transfer material is gripped or the timing at which the transfer material is released by the transfer material gripping mechanism 610.

The developer unit control unit 170 executes adjustments on the circumferential velocity of the photosensitive members 10 in the developer units 30 for each color, the exposure timing of the exposure units 12, and so on based on control commands from the main control unit 150.

The image forming apparatus according to the invention is provided with the transfer member type information storage unit 145, and because the transport unit configured of the first suction unit 210, the transfer material transport device 230, the second suction unit 270, and so on, the blowing unit 400, and the secondary transfer roller control unit 160 are controlled based on the information regarding the transfer material type, the transfer material transport conditions and so on can be easily changed in accordance with the type of transfer material.

Furthermore, the image forming apparatus according to the invention is provided with the toner amount calculation unit 141, and because the transport unit configured of the first suction unit 210, the transfer material transport device 230, the second suction unit 270, and so on, the blowing unit 400, and the secondary transfer roller control unit 160 are controlled based on the amount of toner transferred onto the transfer material, the transfer material transport conditions and so on can be easily changed in accordance with the toner amount.

Furthermore, the image forming apparatus according to the invention is provided with the temperature sensor 146 and the humidity sensor 147, and because the transport unit configured of the first suction unit 210, the transfer material transport device 230, the second suction unit 270, and so on, the blowing unit 400, and the secondary transfer roller control unit 160 are controlled based on temperature information and humidity information obtained by those sensors, the transfer material transport conditions and so on can be easily changed in accordance with the environment in the image forming apparatus.

Furthermore, with the image forming apparatus according to the invention, the airflow rate control units 151, 153, and 157 function as airflow rate adjustment units that adjust the airflow rate when sucking the transfer material. Accordingly, the suction force when the transport unit configured of the first suction unit 210, the transfer material transport device 230, the second suction unit 270, and so on suck the transfer material can, for example, be adjusted in accordance with the type of the transfer material, thereby improving the compatibility of the apparatus with the transfer material types.

To be more specific, if, for example, thin paper and thick paper are sucked with the same suction force, the thin paper is more flimsy than the thick paper, and thus there are cases where the paper is overwhelmed by the suction force and the paper stops at the suction surface 212 and the suction surface 272 without being transported, resulting and wrinkles. However, by reducing the suction force for thin paper to, for example, half the suction force used for thick paper, even the flimsy thin paper can be transported sufficiently, thus preventing the paper from being wrinkled.

Furthermore, with the image forming apparatus according to the invention, the airflow rate control units 151, 153, and 158 function as airflow rate adjustment units that adjust the airflow rate when expelling air using the blowing unit 400. Accordingly, the air expulsion rate of the blowing unit 400 can be adjusted in accordance with, for example, the type of the transfer material, thereby improving the compatibility of the apparatus with the transfer material types.

To be more specific, if thin paper is pressed into the secondary transfer nip exit space between the transfer belt 40 and the secondary transfer roller 61 with the same air expulsion rate as is used for thick paper, the paper will flap under the expelled air. If the paper flaps, the image surface will make contact with the members within the apparatus, which can lead to disturbances in the image, and flapping of the paper can also lead to wrinkles therein. However, by reducing the air expulsion rate for thin paper to, for example, half the air expulsion rate used for thick paper, it is possible to press thin paper into the stated space without that paper flapping.

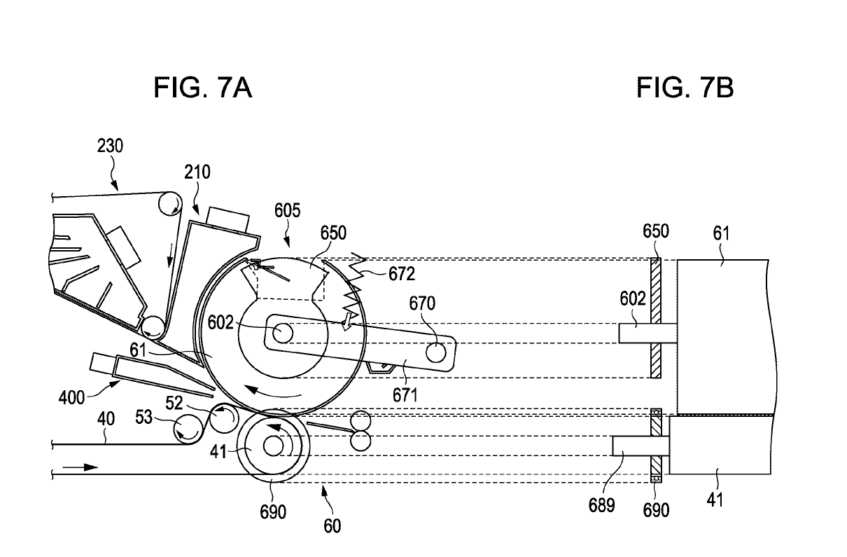

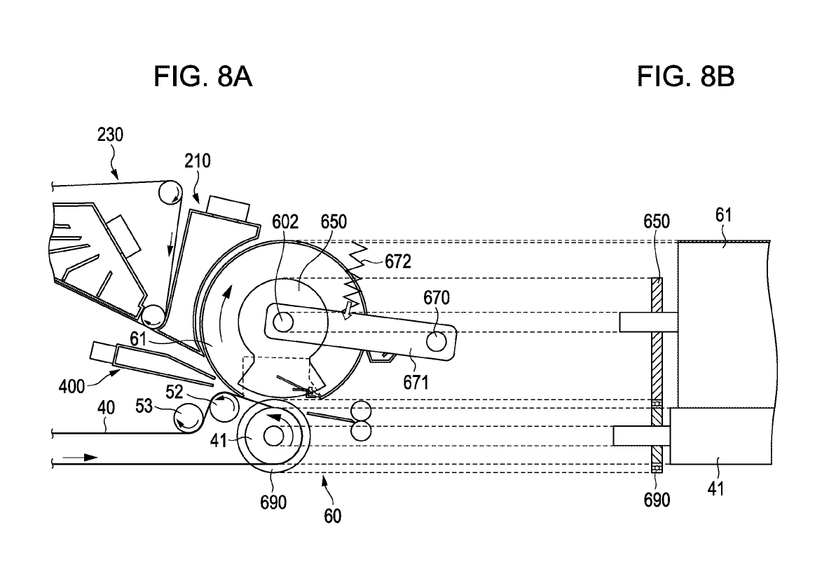

Next, a structure for regulating the position between the secondary transfer roller 61 and the belt driving roller 41 while applying a predetermined force at the secondary transfer nip in the secondary transfer unit 60 configured of the secondary transfer roller 61 provided with the open concaved portion 605 for holding the transfer material gripping mechanism 610 will be described. FIGS. 7A-7B and 8A-8B are diagrams illustrating operations performed by the secondary transfer unit 60 in the image forming apparatus according to this embodiment of the invention. In both FIGS. 7A-7B and 8A-8B, FIGS. 7A and 8A illustrate the secondary transfer unit 60 from the side surface of the apparatus, whereas 7B and 8B illustrate a schematic cross-section of the secondary transfer unit 60. In FIGS. 7A-7B and 8A-8B, the apparatus includes a contact member 650, a rotational support shaft portion 670, a frame member 671, a bias member 672, a roller shaft portion 689 for the belt driving roller 41, and a contacted member 690.

In the secondary transfer unit 60, the roller shaft portion 602 of the secondary transfer roller 61 is attached on both sides to the frame member 671 in a freely-rotatable state. Furthermore, the frame member 671 is rotatable around the rotational support shaft portion 670, and is biased in the direction of the arrow illustrated in FIGS. 7A-7B and 8A-8B by the bias member 672. With this structure, the secondary transfer roller 61 is biased toward the belt driving roller 41, making it possible to apply a predetermined pressure at the secondary transfer nipping point between the secondary transfer roller 61 and the belt driving roller 41. Toner particles upon the transfer belt 40 are transferred to the transfer material in an efficient manner at the secondary transfer nipping point due to the transfer pressure at the secondary transfer nipping point and the transfer bias.

The two contact members 650 are provided on the roller shaft portions 602, one on either side of the secondary transfer roller 61. The two contacted members 690 are provided on either side of the roller shaft portion 689 of the belt driving roller 41 so as to correspond to the respective contact members 650. As shown in FIGS. 7B and 8B, the contact members 650 and the contacted members 690 are disposed so that their positions are aligned in the axial direction.

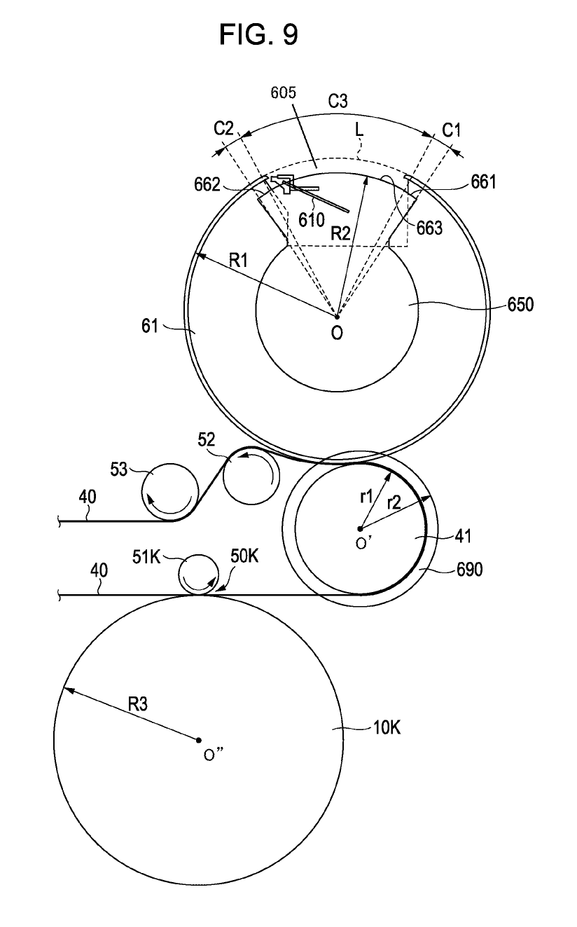

FIG. 9 illustrates the configurations of the contact members and the contacted members according to this embodiment of the invention. The contact members 650 are shaped as illustrated in FIG. 9, and each is provided with a contact surface 663 at a distance R2 from the rotational center O of the secondary transfer roller 61. A first delivery surface 661 for suppressing impacts when the belt driving roller 41 and the contacted member 690 begin to make contact with each other is provided on one side of the contact surface 663, whereas a second delivery surface 662 for suppressing impacts when the belt driving roller 41 detaches from the contacted member 690 is provided on the other side of the contact surface 663.

The contact surface 663 is provided in a region so as to correspond to the open concaved portion 605 and forms a contact region C3. When the open concaved portion 605 is positioned opposite to the belt driving roller 41 (or the transfer belt 40) as a result of the operation of the apparatus, the contact surface 663 (contact region C3) makes contact with the contacted member 690 of the belt driving roller 41. As a result, the bias pressure of the secondary transfer roller 61 is exerted upon the contacted member 690, thus maintaining the distance and positional relationship between the secondary transfer roller 61 and the belt driving roller 41.

In this embodiment, the sum of a radius R1 of the secondary transfer roller and a radius r1 of the belt driving roller 41 is set so as to be approximately equal to the sum of a radius R2 at the contact surface 663 of the contact member 650 and a radius r2 of the contacted member 690. According to this configuration, even when the open concaved portion 605 of the secondary transfer roller 61 is positioned opposite to the belt driving roller 41, the contact members 650 and the contacted members 690 make contact with each other, thus maintaining the positional relationship between the secondary transfer roller 61 and the belt driving roller 41 in the same manner as when an imaginary arc L is provided connecting both ends of the open concaved portions 605 to each other.

A state of a fixed load in which a constant pressure is applied at the secondary transfer nipping point and an oriented state achieved by the contact members 650 and the contacted members 690 are repeated in an alternating manner due to the rotation of the secondary transfer roller 61 and the belt driving roller 41. Due to the first delivery surface 661 (the region C1) and the second delivery surface 662 (the region C2) provided on both sides of the contact surface 663, these states can be transited between seamlessly without the occurrence of vibrations or the like, making it possible to suppress influences on the image formation process and prevent a drop in image quality. Although the first delivery surface 661 (the region C1) and the second delivery surface 662 (the region C2) are formed as tapered surfaces in this embodiment, these surfaces may be curved surfaces having a predetermined curvature factor.

The contacted members 690 are members whose external edges are located at a distance r2 from the rotational center O′ of the belt driving roller 41, and are provided with sliding portions such as bearings that smoothly rotate the contact surfaces in order to suppress resistance during contact with the contact members 650. The configuration is such that the distance and positional relationship between the secondary transfer roller 61 and the belt driving roller 41 are maintained by the contacted members 690. The contacted members 690 receive the load of the secondary transfer roller 61 biased by the bias member 672, and make contact with the contact surfaces 663 of the contact members 650 accompanying the rotations of the various rollers.

The secondary transfer unit 60 repeatedly transits from the state shown in FIGS. 7A-7B to the state shown in FIGS. 8A-8B and back again due to the rotational operations of the various rollers. FIGS. 7A-7B illustrate the state in which the open concaved portion 605 is not facing the belt driving roller 41 (or the transfer belt 40). At this time, the biasing force from the bias member 672 is exerted on the secondary transfer nipping point and a predetermined transfer pressure is secured, and furthermore, an appropriate transfer bias is applied between the secondary transfer roller 61 and the belt driving roller 41. As a result, toner particles upon the transfer belt 40 are transferred onto the transfer material at the secondary transfer nipping point. In this state, the contact members 650 are completely detached from the contacted members 690, and thus no positional regulation is in effect.

FIGS. 8A-8B, meanwhile, illustrate a state in which the open concaved portion 605 face the belt driving roller 41 (or the transfer belt 40). At this time, the contact surfaces 663 of the contact members 650 (the region C3) are in contact with the contacted members 690, and the contacted members 690 are subjected to the biasing pressure of the secondary transfer roller 61 that is biased by the bias member 672, thus maintaining the distance and positional relationship between the secondary transfer roller 61 and the belt driving roller 41.

According to this embodiment, the secondary transfer roller 61 is biased toward the belt driving roller 41, and because the structure includes the contact members 650 disposed on the shaft portions of the secondary transfer roller 61 and the contacted members 690 disposed on the shaft portions of the belt driving roller 41, the secondary transfer roller 61 can apply a predetermined amount of pressure at the transfer nipping point when the open concaved portions 605 are not in contact with the transfer belt and the positional relationship between the secondary transfer roller 61 and the belt driving roller 41 can be maintained when the open concaved portion is opposite the transfer belt.

According to the embodiment described thus far, a state of a fixed load in which a constant pressure is applied at the secondary transfer nip and an oriented state in which the positional relationship between the secondary transfer roller 61 and the belt driving roller 41 is held constant can be transited between in a smooth manner without causing vibrations or the like even in the case where the secondary transfer roller 61 having the open concaved portion 605 is used, and it is thus possible to prevent a drop in image quality without negatively influencing the image formation process.

With an image forming apparatus currently known in the art that uses a roller having such a concaved portion, rotational unevenness arising due to skew in the center of the roller, or in other words, eccentricity or wobbles in the roller, velocity fluctuations arising due to fluctuations in the load at the concaved portion, and so on may be transmitted to the photosensitive member or the like, resulting in skew at the primary transfer portion of the photosensitive member, the exposure unit, or the like. This skew is a cause of unevenness in the image formed on the transfer material. In consideration of the visual characteristics of the human eye, which is sensitive to changes in darkness, changes in darkness arising due to this image unevenness are easily identifiable as image degradation, particularly in areas where the image darkness is intended to be uniform. Furthermore, with such image forming apparatuses that handle color images, this skew can cause registration error, which is skew between the multiple colors when those colors are overlapped, and is thus problematic when forming images.

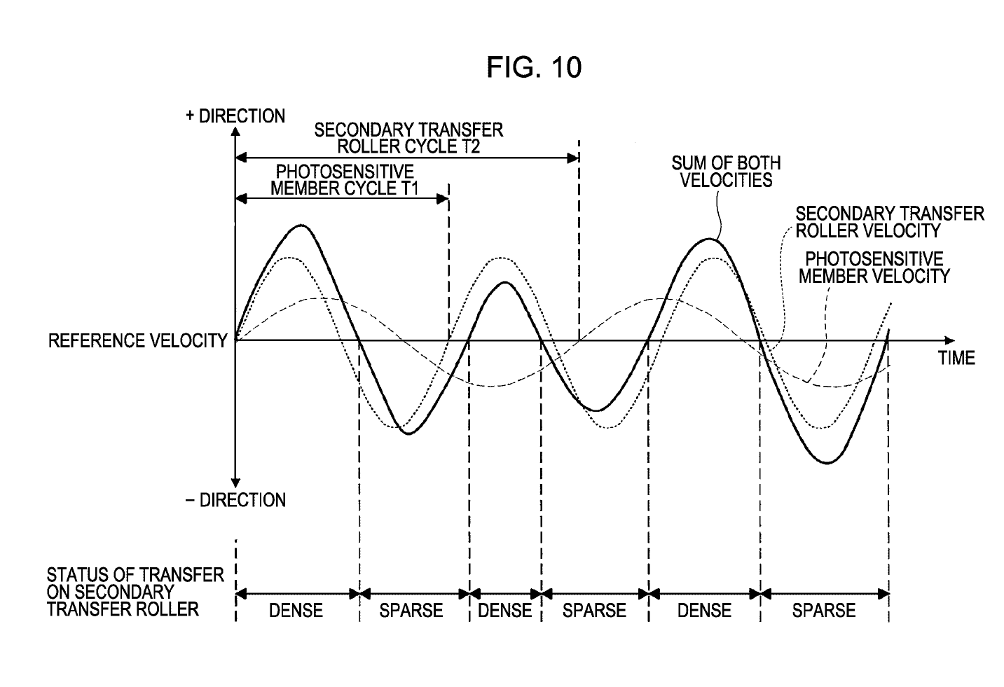

FIG. 10 is a diagram illustrating fluctuations in the circumferential velocity of the photosensitive member 10 and secondary transfer roller 61 arising in the image forming apparatus and image unevenness arising due to those fluctuations. The configuration of the image forming apparatus is the same as that shown in FIG. 9. The velocity fluctuation caused by eccentricity in the rollers and so on occurs cyclically with each rotation thereof. FIG. 10 illustrates the velocity fluctuation of the photosensitive member 10 and the velocity fluctuation of the secondary transfer roller 61, where the velocity fluctuation cycle of the photosensitive member 10 is T1, and the velocity fluctuation cycle of the secondary transfer roller 61 is T2.

While it is possible for velocity fluctuations to arise in the various rollers that drive the transfer belt 40, such as the belt driving roller 41 and so on, such velocity fluctuations in the transfer belt 40 are cancelled out by the transfer from the photosensitive member 10 to the transfer belt 40 and the transfer from the transfer belt 40 to the secondary transfer roller 61 and are of a degree that can essentially be ignored, and thus are not taken into consideration here. Accordingly, image unevenness ultimately appearing in the transfer material arises depending on both the velocity fluctuation of the photosensitive member 10 and the velocity fluctuation of the secondary transfer roller 61.

In FIG. 10, the sum of the velocities of the photosensitive member 10 and the secondary transfer roller 61 is illustrated by a solid line. The transfer state of the image transferred onto the secondary transfer roller 61, or in other words, the image formed upon the transfer material is influenced by the fluctuation amount in this sum. A “dense” state in which the darkness is greater than the original image is formed in areas where the stated sum is greater than an original reference velocity, whereas a “sparse” state in which the darkness is less than the original image is formed in areas where the stated sum is less than the original reference velocity.

The invention has a characteristic of being configured so as to respond with ease to such image unevenness arising due to fluctuation in the circumferential velocity caused by roller eccentricity and so on. Specifically, the configuration responds with ease to image unevenness by setting the cycle of the photosensitive member 10 at an integral multiple or an approximate integral multiple of the cycle of the secondary transfer roller 61, thereby matching or approximately matching the cycle of the image unevenness arising based on velocity fluctuations in those elements to the cycle of the secondary transfer roller 61, and adjusting the exposure timing of the exposure unit 11, adjusting the velocity of the photosensitive member 10, adjusting the velocity of the secondary transfer roller 61, or adjusting the formed image itself within that cycle.

To be even more specific, setting an imaginary rotational circumference of the secondary transfer roller 61 to an integral multiple or an approximate integral multiple of the circumference of the photosensitive member 10 makes it possible to set the cycle of the photosensitive member 10 to an integral multiple or an approximate integral multiple of the cycle of the secondary transfer roller 61. Here, the “imaginary rotational circumference” is defined for the secondary transfer roller 61 because the secondary transfer roller 61 includes the open concaved portion 605. In actuality, the imaginary rotational circumference of the secondary transfer roller 61 is formed by the elastic member 607 (support portion) that is wrapped upon the roller base member 601. Note that when the imaginary rotational circumference of the secondary transfer roller 61 and the circumference of the photosensitive member 10 are in a relationship 1:a, the rotational angular velocity between the secondary transfer roller 61 and the photosensitive member 10 is set to a relationship 1:1/a.

This imaginary rotational circumference is prescribed based on the sum of the circumference of the secondary transfer roller 61 that makes contact with the transfer belt 40 and the circumference of the imaginary arc L in the secondary transfer roller 61 that is formed by the contact members 650 and the contacted members 690. Control for eliminating image unevenness is simplified by setting the imaginary rotational circumference of the secondary transfer roller 61 to an approximate integral multiple of the circumference of the photosensitive member 10, and it is possible to eliminate image unevenness by setting this within an error range of ±5%.

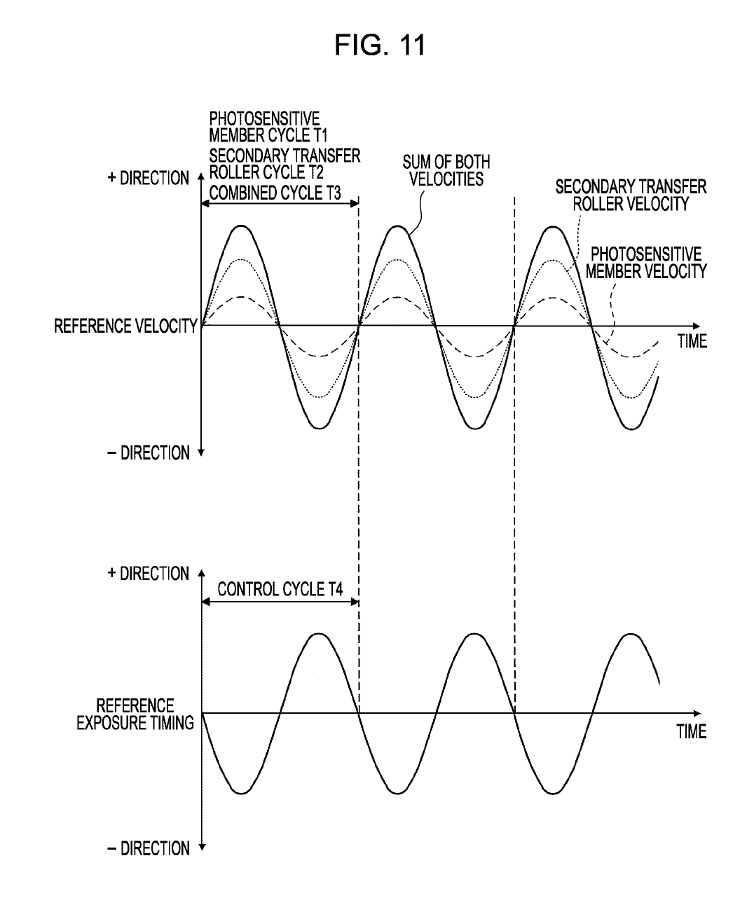

FIG. 11 is a diagram illustrating the state of velocity fluctuations in the case where the circumference of the photosensitive member 10 is caused to match the imaginary rotational circumference of the secondary transfer roller 61, or in other words, in the case where the circumference of the photosensitive member 10 and the imaginary rotational circumference of the secondary transfer roller 61 are in a 1:1 relationship, as well as the exposure timing of the exposure unit 12. In order to make the descriptions easier to understand, the starting points of the velocity fluctuations of the photosensitive member 10 and the secondary transfer roller 61 are illustrated as being aligned. In this embodiment, the circumference of the photosensitive member 10 and the imaginary rotational circumference of the secondary transfer roller 61 are both set to a length of 300 mm.

As can be seen from FIG. 11, when the circumference of the photosensitive member 10 and the imaginary rotational circumference of the secondary transfer roller 61 have been set to a 1:1 relationship, the cycle T1 of the velocity fluctuation of the photosensitive member 10 and the cycle T2 of the velocity fluctuation of the secondary transfer roller 61 match, and the combination of these two matches with a cycle T3. Accordingly, the cycle of image unevenness that occurs in the transfer material is dependent upon T3, and thus the image unevenness can easily be eliminated by repeating various types of processes during the cycle T3.

FIG. 11 illustrates a process that adjusts the exposure timing performed by the exposure unit 12, and more specifically, adjusts to phase-invert the combined velocity fluctuations in the exposure timing with respect to the rotational direction of the photosensitive member 10, as an example of a process for eliminating this image unevenness. The adjustment of the exposure timing can be realized by detecting rotational fluctuations occurring in the secondary transfer roller 61 and the photosensitive member 10 in advance and storing a control pattern based thereon in the developer unit control unit 170. Alternatively, instead of detecting rotational fluctuations in the rollers, the image unevenness may be detected directly by printing a printed pattern such as a patch.

Accordingly, in this embodiment, causing the imaginary rotational circumference of the secondary transfer roller 61 and the circumference of the photosensitive member 10 to match results in the cycles of the velocity fluctuation of the secondary transfer roller 61 and the velocity fluctuation of the photosensitive member 10 matching the cycle of the secondary transfer roller 61, making the processing for image unevenness a processing that can easily be carried out within the cycle of the secondary transfer roller 61.

Note that in the case of an image forming apparatus that uses multiple developer units 30 for various colors, such as that illustrated in FIG. 1, exposure timing control is executed for each of the exposure units 12 in the respective developer units 30. Furthermore, the processing for image unevenness is not limited to the adjustment of the exposure timing, and may be carried out by adjusting the circumferential velocity of the photosensitive member 10. In this case, the circumferential velocity of the photosensitive member 10 is adjusted so as to cancel out the sum of the velocity fluctuation of the photosensitive member 10 and the velocity fluctuation of the secondary transfer roller 61, thereby enabling the occurrence of image unevenness to be suppressed. In addition, adjusting the circumferential speed of the secondary transfer roller 61, adjusting the image signal itself that is inputted into the exposure unit 12, and so on may be performed as processing for image unevenness. In any case, eliminating the image unevenness can be achieved by performing control at an inverse phase relative to the combined velocity fluctuations.

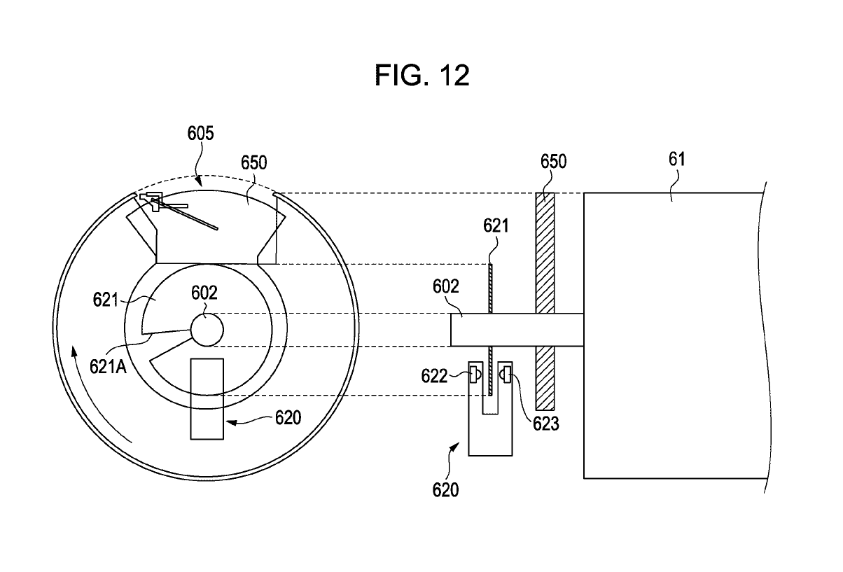

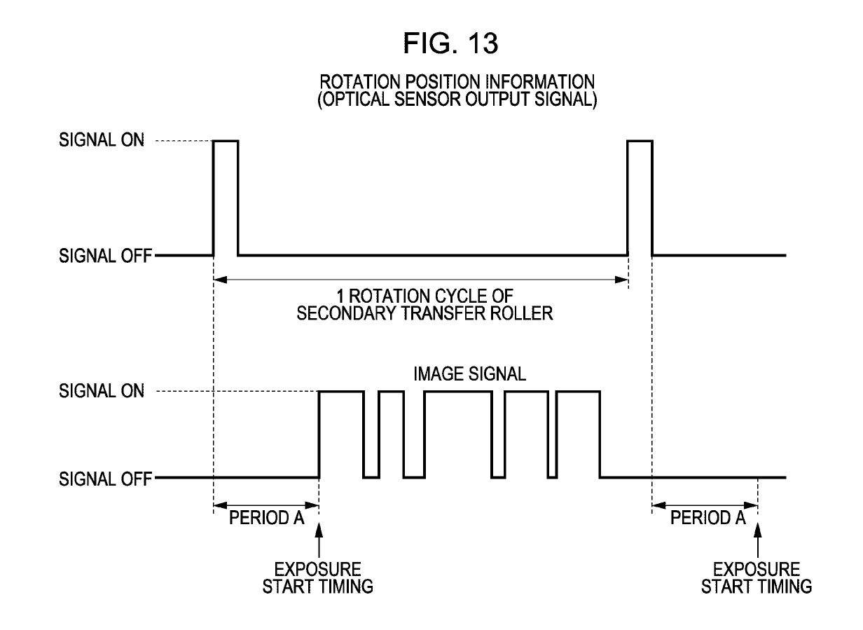

Next, the timing of rotation reference position detection of the secondary transfer roller 61 and the start of processing for eliminating image unevenness through reference position detection will be described using FIGS. 12 and 13. FIG. 12 is a diagram illustrating a rotation position detection portion 620 provided at the end of the secondary transfer roller 61. In this embodiment, the rotation position detection portion 620 detects a rotation reference position using rotation position information outputted by an optical sensor.

The rotation position detection portion 620 is configured of a disk 621 in which a cutout 621A is provided. The rotation position detection portion 620 also includes an optical sensor having a light-emitting portion 622 and a light-receiving portion 623. The disk 621 is anchored to the roller shaft portion 602 of the secondary transfer roller 61, and is a circular-shaped member that rotates along with the secondary transfer roller 61. The disk 621 is configured, as shown in FIG. 12, with a cutout 621A provided therein.

The light-emitting portion 622 is configured of a component that emits light, such as a light-emitting diode, an LED, or the like, and is disposed in a position opposite to the light-receiving portion 623 with the disk 621 therebetween. Furthermore, the light-emitting portion 622 and the light-receiving portion 623 are anchored at predetermined locations within the image forming apparatus, and are disposed so as not to rotate with the secondary transfer roller 61. The cutout 621A provided in the disk 621 is configured so as to pass between the light-emitting portion 622 and the light-receiving portion 623 as the secondary transfer roller 61 rotates. When the cutout portion 621A is between the light-emitting portion 622 and the light-receiving portion 623, the light-receiving portion 623 receives light emitted from the light-emitting portion 622 and enters an “on” state, whereas when the cutout portion 621A is not between the stated portions, the light-receiving portion 623 enters an “off” state. Although this embodiment describes detecting a reference position of the secondary transfer roller 61 from rotation position information outputted by the rotation position detection portion 620 that uses an optical system, the reference position detection is not limited to this form only, and the reference position can be detected by employing any appropriate form, such as using light reflected by the disk 621, using a mechanical position, and so on.

FIG. 13 illustrates the rotation position information outputted from this optical sensor. As shown in FIG. 13, the rotation position information from the optical sensor enters the “on” state when the cutout passes the light-emitting portion 622 and the light-receiving portion 623 with each rotational cycle of the secondary transfer roller 61, thereby making it possible to detect a reference position of the secondary transfer roller 61 when that position passes a predetermined position.

In this embodiment, it is possible, in the processing for eliminating image unevenness, to suppress image unevenness with even higher accuracy by using the passage of the reference position of the secondary transfer roller 61 as a starting trigger. In particular, in the case where the secondary transfer roller 61 is rotationally driven using a driving unit such as a motor, performing processing based on the rotation position of the secondary transfer roller 61 makes it possible to bring the timing of the processing for eliminating image unevenness closer to the timing at which the image unevenness occurs, thereby achieving improved accuracy.

FIG. 13 illustrates the timing of the start of exposure carried out in accordance with the timing at which the reference position passes. An exposure based on an image signal commences after a predetermined period A has elapsed following the rise of the rotation position information. This period A is a predetermined value set for the exposure unit 12 of each of the colors based on the phase of the cutout 621A provided in the disk 621 in the secondary transfer roller 61 and so on, so that the image formed based upon the image signal is formed upon the secondary transfer roller 61. Meanwhile, the timing of exposures performed by the exposure unit 12 is adjusted using this timing at which the reference position passes. Using the secondary transfer roller 61 in which the image unevenness actually occurs as a reference makes it possible to more accurately align the timing of the occurrence of the image unevenness with the processing performed in response thereto, thus enabling highly-accurate processing to be realized.

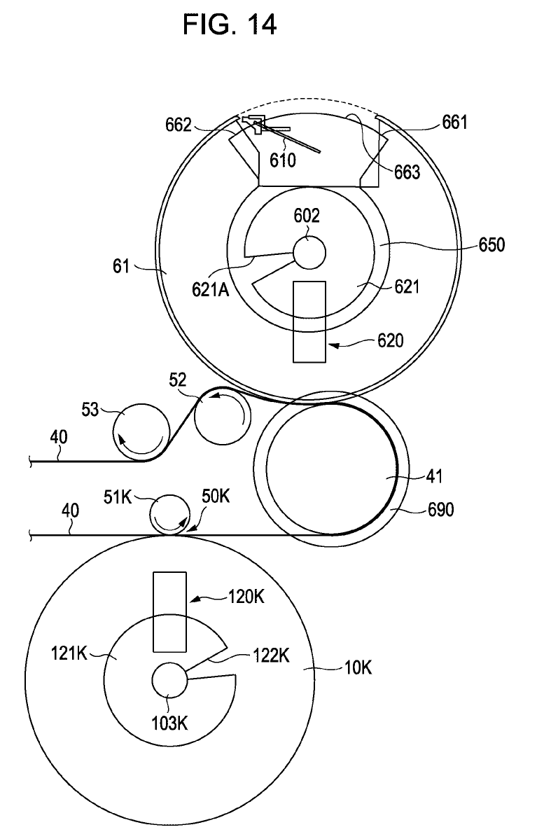

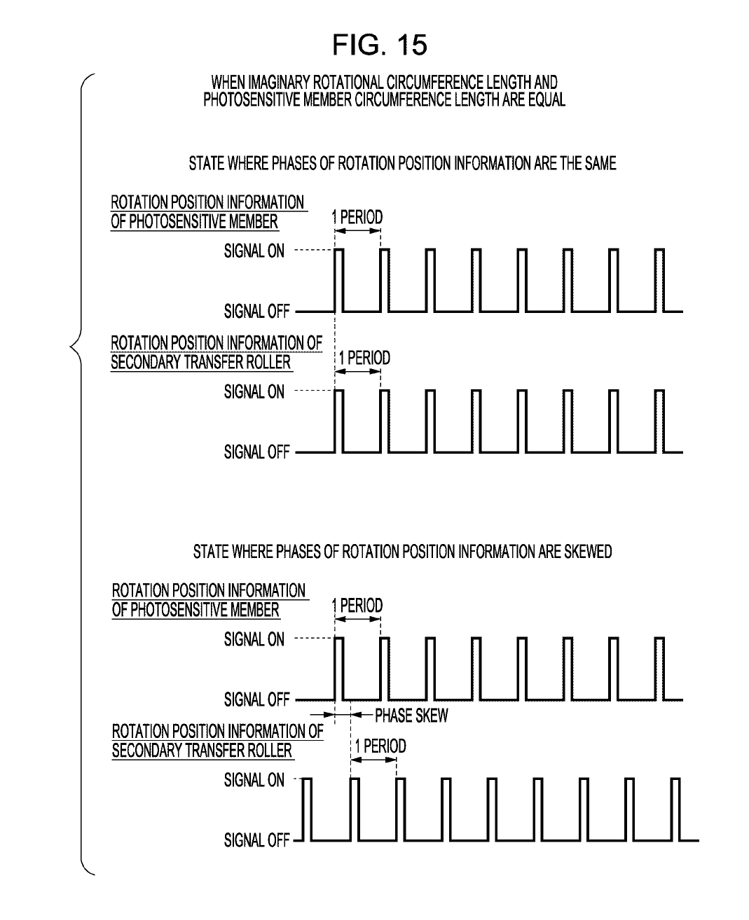

FIGS. 14 and 15 are diagrams illustrating phase alignment control for the secondary transfer roller 61 and the photosensitive member 10 in the image forming apparatus according to this embodiment of the invention. FIG. 14 illustrates the configuration for achieving this control, whereas FIG. 15 illustrates the state of the phases. Although multiple photosensitive members 10 are provided in a color image forming apparatus, the K color photosensitive member 10K will be described as an example here.

Even in the case where the imaginary rotational circumference of the secondary transfer roller 61 has been set to an integral multiple of the circumference of the photosensitive member 10, there are cases where the cycle of the secondary transfer roller 61 is skewed relative to the cycle of the photosensitive member 10 due to error in the stated circumferences, error in the rotational velocities of the rollers, and so on. Because this cycle skew grows as time passes, it is necessary to perform correction, or in other words, to align the phases of the secondary transfer roller 61 and the photosensitive member 10, when a certain amount of skew has occurred.

As shown in FIG. 14, when the secondary transfer roller 61 and the photosensitive member 10K have their phases aligned, a reference position is necessary for the photosensitive member 10K, and thus a rotation position detection portion 120K is provided for the photosensitive member 10K as well. In this embodiment, the rotation position detection portion 120K is disposed so as to detect a reference position by detecting a cutout 122K in a disk 121K using an optical system, in the same manner as with the rotation position detection portion 620 of the secondary transfer roller 61. By providing the position detection units 120K and 620 in the photosensitive member 10K and secondary transfer roller 61, respectively, in this manner and performing corrective control so that the respective phases thereof match, skew in the cycles can be eliminated and the processing for image unevenness can be carried out with more certainty.

FIG. 15 is a diagram illustrating the rotation position information of the rotation position detection portion 120K of the photosensitive member 10K and the rotation position detection portion 620 of the secondary transfer roller 61, respectively, in the case where the imaginary rotational circumference of the secondary transfer roller 61 and the circumference of the photosensitive member 10K have been set to be equal.

As illustrated in FIG. 13, the rotation position information of the secondary transfer roller 61 enters an “on” state with the passage of the cutout 621A provided in the disk 621. The rotation position information of the photosensitive member 10K acts in the same manner, thus entering an “on” state with the passage of the cutout 122K provided in the disk 121K. In the case where the imaginary rotational circumference of the secondary transfer roller 61 and the circumference of the photosensitive member 10K are equal or approximately equal, the timing at which the two instances of rotation position information rise to the “on” state is equal, and thus the state is a so-called “phase aligned” state. Accordingly, no impediments arise with respect to the control for image unevenness.

However, there are cases where these phases are skewed due to error in the circumferences of the secondary transfer roller 61 or the photosensitive member 10K, error in the rotational velocity of the rollers, and so on. The lower section of FIG. 15 illustrates a state occurring when the phases are skewed, and in the case where such phase skew has occurred, skew also occurs with respect to the control for image unevenness. Here, in the case where the phase skew is greater than or equal to a predetermined value, the phase skew is eliminated by adjusting the rotational velocity of the photosensitive member 10K through the developer unit control unit 170. In this embodiment, when the phase skew has become greater than or equal to 50 msec, corrective control of the phase skew is executed by stopping printing and adjusting the rotational velocity of the photosensitive member 10K.

In this manner, performing corrective control on skew in the phases of the secondary transfer roller 61 and the photosensitive member 10K makes it possible to eliminate skew in the cycles and perform the processing for image unevenness with certainty. Although the single photosensitive member 10K has been described here as an example, it should be noted that rotation position detection portions 120Y, 120M, and 120C can be provided for the photosensitive members 10Y, 10M, and 10C, respectively, for the other colors as well, and phase skew can be eliminated therein by performing the same type of corrective control.

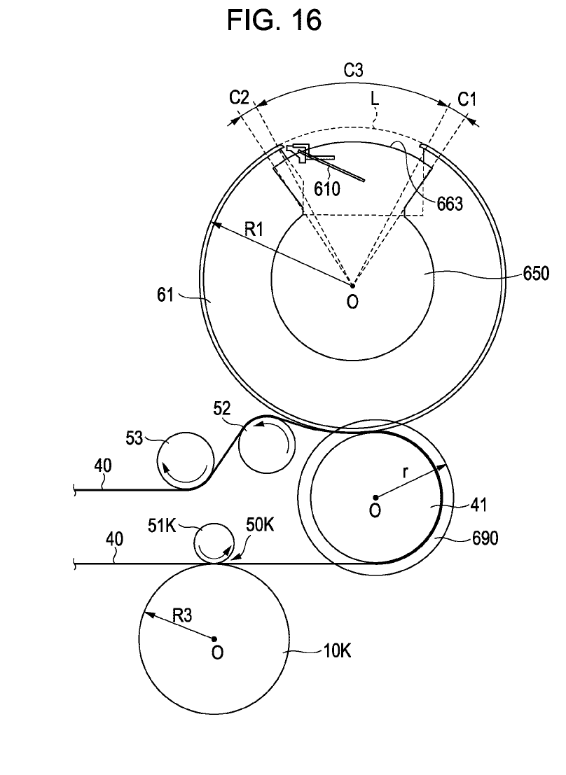

FIG. 16 is a diagram illustrating an image forming apparatus according to another embodiment of the invention. In this image forming apparatus, the imaginary rotational circumference of the secondary transfer roller 61 is set to twice or approximately twice the circumference of the photosensitive member 10 (where “approximately” means within an error range of ±5%). To be more specific, assuming the circumference of the photosensitive member 10 is 300 mm, the imaginary rotational circumference of the secondary transfer roller 61 is set to 600 mm. As with the aforementioned embodiment, this configuration is a configuration responds with ease to velocity fluctuations occurring in the photosensitive member 10 and the secondary transfer roller 61.

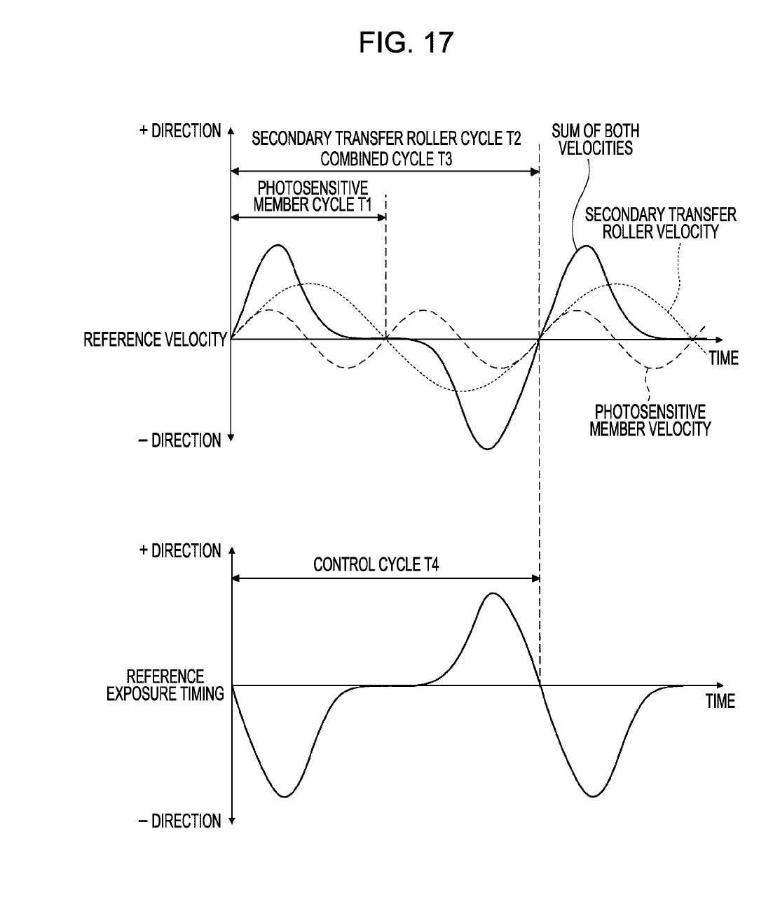

FIG. 17 is a diagram illustrating velocity fluctuations in the photosensitive member 10 and secondary transfer roller 61 illustrated in FIG. 16 and the adjustment of the exposure timing. As with FIG. 11, in order to make the descriptions easier to understand, the starting points of the velocity fluctuations of the photosensitive member 10 and the secondary transfer roller 61 are illustrated as being aligned.

As shown in FIG. 17, the photosensitive member 10 makes two rotations within the cycle T2 in which the secondary transfer roller 61 makes one rotation, or in other words, two cycles T1 of the photosensitive member 10 are contained within a single cycle T2. The cycle T3 of the combined waveform of the stated two cycles thus matches or approximately matches the cycle of the secondary transfer roller 61. Accordingly, when adjusting the exposure timing of the exposure unit 12 to an inverse phase relative to this velocity fluctuation combined waveform, the occurrence of image unevenness can be eliminated by repeating control within the cycle T2 of the secondary transfer roller 61.

Setting the imaginary rotational circumference of the secondary transfer roller 61 to twice or approximately twice (where “approximately” means within an error range of ±5%) the circumference of the photosensitive member 10 in this manner makes it possible to perform the processing for eliminating image unevenness in a cyclic manner, and makes it possible to simplify that processing as well. Although this embodiment describes setting the imaginary rotational circumference of the secondary transfer roller 61 to an integral multiple one or two times the circumference of the photosensitive member 10, the same effects can be achieved even if the integral multiple is three times or more.

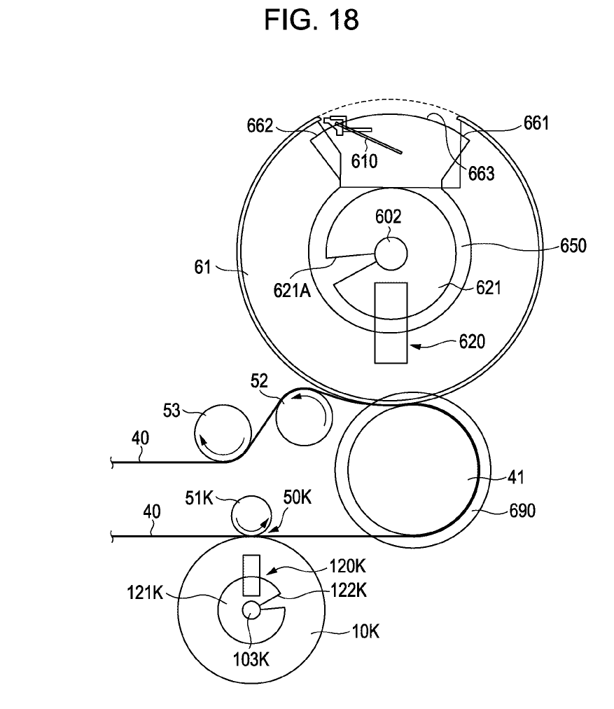

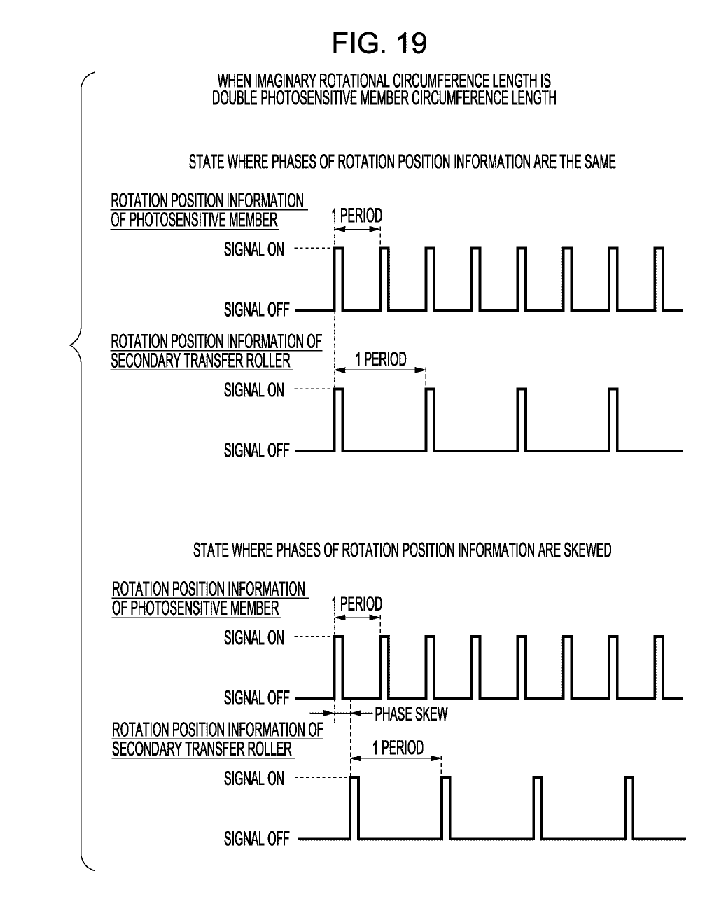

FIGS. 18 and 19 are diagrams respectively illustrating a configuration for performing phase alignment in the case where the imaginary rotational circumference of the secondary transfer roller 61 is set to twice the circumference of the photosensitive member 10K, and the state of phases therein. Employing a configuration for correcting phase skew makes it possible to perform the processing for image unevenness with certainty in this embodiment as well, in the same manner as illustrated in FIGS. 14 and 15.

As shown in FIG. 18, rotation position detection portions 620 and 120K for detecting reference positions of the secondary transfer roller 61 and photosensitive member 10K, respectively, are provided in this embodiment as well. FIG. 19 is a diagram illustrating rotation position information of the rotation position detection portions 620 and 120K, and in this embodiment, due to the relationship between the circumferences, two cycles of the rotation position information of the photosensitive member 10K are present within a single cycle of the rotation position information of the secondary transfer roller 61. When the phase skew between the rotation position information of the photosensitive member 10K and the secondary transfer roller 61 has increased, an improvement in the accuracy of the processing for image unevenness can be achieved by adjusting the rotational velocity of the photosensitive member 10K.

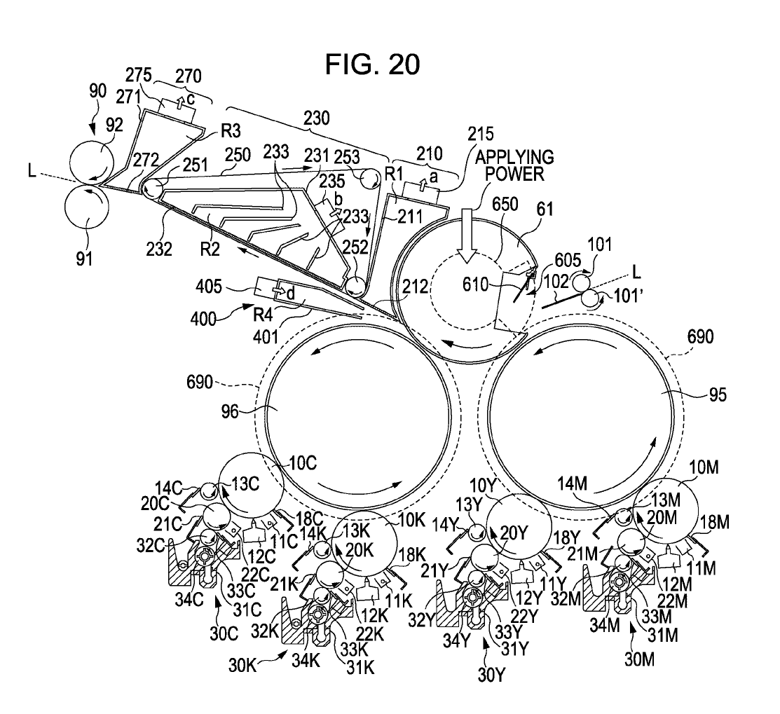

Next, another embodiment of the invention shall be described. FIG. 20 is a diagram illustrating the primary constituent elements of which an image forming apparatus according to another embodiment of the invention is configured. Constituent elements having the same reference numerals as those in the preceding embodiments are the same as the corresponding constituent elements described earlier, and thus descriptions thereof will be omitted. This embodiment differs from the preceding embodiments in that while the transfer belt 40 is used as an intermediate transfer medium in the preceding embodiments, a first transfer roller 95 and a second transfer roller 96 are used as the intermediate transfer medium in this embodiment. Furthermore, in this embodiment, the imaginary rotational circumference of the secondary transfer roller 61 is set to approximately twice the circumferences of the photosensitive members 10Y, 10M, 10C, and 10K.

Yellow (Y) and magenta (M) toner images are formed upon the first transfer roller 95 by the developer units 30Y and 30M, whereas cyan (C) and black (K) toner images are formed upon the second transfer roller 96 by the developer units 30C and 30K. The secondary transfer roller 61 is biased toward the first transfer roller 95 and the second transfer roller 96 by a mechanism (not shown), and a predetermined pressure is obtained at the respective nipping portions during transfers.

A full-color toner image is formed on the transfer material gripped by the transfer material gripping mechanism 610 by that transfer material passing through the nipping point between the first transfer roller 95 and the secondary transfer roller 61 and the nipping point between the second transfer roller 96 and the secondary transfer roller 61.

As with the preceding embodiments, the two contact members 650 are provided on the roller shaft portion of the secondary transfer roller 61. Meanwhile, a first contacted member 690 is provided on the roller shaft portion of the first transfer roller 95, while a second contacted member 690 is provided on the roller shaft portion of the second transfer roller 96. Accordingly, the imaginary rotational circumference of the secondary transfer roller 61 is determined by the contacting relationship between the contact members 650 and the first, second contacted members 690.

The secondary transfer roller 61 is biased toward the first transfer roller 95 and the second transfer roller 96, and because the structure is such that the contact members 650 are provided on the shaft portion of the secondary transfer roller 61 and the first and second contacted members 690 are provided on the shaft portions of the first transfer roller 95 and the second transfer roller 96 respectively, the secondary transfer roller 61 can apply a predetermined pressure at the transfer nips when the open concaved portion 605 is not making contact with the transfer rollers, and the positional relationship between the secondary transfer roller 61 and the transfer rollers can be maintained when the open concaved portion 605 is positioned opposite to the transfer rollers.

This embodiment, which employs these rollers (the first transfer roller 95 and the second transfer roller 96) as the intermediate transfer member, can also easily control the occurrence of image unevenness arising in the respective rollers as a cyclic occurrence by setting the imaginary rotational circumference of the secondary transfer roller 61 to an integral multiple or an approximate integral multiple of the circumference of the photosensitive member 10. Furthermore, detecting a rotational reference position of the secondary transfer roller 61 in which the image unevenness actually occurs by using a rotation position detection portion employing an optical sensor or the like makes it possible to align the processing for image unevenness with the occurrence of that image unevenness, thus making it possible to achieve an improvement in image quality.

Although various embodiments of the invention have been described in this specification, other embodiments obtained by combining, as appropriate, the configurations described in the preceding embodiments also fall within the scope of the invention.

What is claimed is:

1. An image forming apparatus comprising:
a latent image bearing drum on which a latent image is formed;
an exposure unit that forms the latent image by exposing the latent image bearing drum;
a developer unit that develops the latent image formed on the latent image bearing drum;
a transfer medium onto which an image developed by the developer unit is transferred; and
a transfer roller that transfers the image that has been transferred onto the transfer medium to the transfer material, the transfer roller including a roller base member having a concaved portion extending in an axial direction and a support portion disposed on an outer circumference of the roller base member, the support portion supporting the transfer material,
wherein an imaginary outer circumference of the support portion assuming that the concaved portion is not formed is approximately an integral multiple of a circumference of the latent image bearing drum.

2. The image forming apparatus according to claim 1, wherein the concaved portion has a gripping member that grips the transfer material as the transfer roller rotates and a detaching member that detaches the transfer material gripped by the gripping member disposed therein.

3. The image forming apparatus according to claim 1, further comprising a transfer roller rotation position detector that detects the rotation position of the transfer roller.

4. The image forming apparatus according to claim 3, further comprising a latent image bearing drum rotation position detector that detects the rotation position of the latent image bearing drum.

5. The image forming apparatus according to claim 4, further comprising:
a driving control unit that adjusts a rotational velocity of the latent image bearing drum,
wherein the driving control unit controls the rotational velocity of the latent image bearing drum based on rotation position information of the transfer roller detected by the transfer roller rotation position detector and rotation position information of the latent image bearing drum detected by the latent image bearing drum rotation position detector.

6. An image forming method comprising:
developing a latent image formed on a latent image bearing drum;
transferring an image developed on the latent image bearing drum onto a transfer medium; and
transferring the image that has been transferred onto the transfer medium to a transfer material using a transfer roller including a roller base member having a concaved portion extending in an axial direction and a support portion disposed on an outer circumference of the roller that supports the transfer material,
wherein an imaginary outer circumference of the support portion assuming that the concaved portion is not formed is approximately an integral multiple of a circumference of the latent image bearing drum.

7. The image forming method according to claim 6, further comprising:
detecting the rotation position of the transfer roller and detecting the rotation position of the latent image bearing drum; and
adjusting the rotation position of the latent image bearing drum by controlling the rotational velocity of the latent image bearing drum based on detected rotation position information of the transfer roller and rotation position information of the latent image bearing drum.

8. An image forming apparatus comprising:
a latent image bearing drum on which a latent image is formed;
an exposure unit that forms the latent image by exposing the latent image bearing drum;
a developer unit that develops the latent image formed on the latent image bearing drum;
a transfer medium onto which an image developed by the developer unit is transferred; and
a transfer roller that transfers the image that has been transferred onto the transfer medium to the transfer material, the transfer roller including a concaved portion extending in an axial direction and a support portion, disposed on an outer circumference of the roller base member, the support portion supporting the transfer material and the concaved portion being capable of gripping and releasing the transfer material as the transfer roller rotates,
wherein an imaginary circumference of the support portion, which is approximately equal to the outer circumference of the roller base member assuming that the concaved portion is not formed, is approximately an integral multiple of the circumference of the latent image bearing drum.

9. The image forming apparatus according to claim 8, wherein the concaved portion has a gripping member that grips the transfer material as the transfer roller rotates and a detaching member that detaches the transfer material gripped by the gripping member disposed therein.

10. The image forming apparatus according to claim 9, further comprising a transfer roller rotation position detector that detects the rotation position of the transfer roller.

11. The image forming apparatus according to claim 10, further comprising a latent image bearing drum rotation position detector that detects the rotation position of the latent image bearing drum.

12. The image forming apparatus according to claim 11, further comprising:
a driving control unit that adjusts a rotational velocity of the latent image bearing drum,
wherein the driving control unit controls the rotational velocity of the latent image bearing drum based on rotation position information of the transfer roller detected by the transfer roller rotation position detector and rotation position information of the latent image bearing drum detected by the latent image bearing drum rotation position detector.
